(19) United States
(12) Patent Application Publication
(10) Pub. No.: US 2026/0174142 A1
(43) Pub. Date: Jun. 25, 2026

(54) COSMETIC-COMPONENT ATOMIZATION APPARATUS AND COSMETIC DEVICE

(71) Applicant: Panasonic Intellectual Property Management Co., Ltd., Osaka (JP)

(72) Inventors: AYA ISHIHARA, Osaka (JP); RISE YABUUCHI, Shiga (JP); MIEI ASANO, Shiga (JP); AKIRA KATAOKA, Hyogo (JP)

(21) Appl. No.: 19/134,764

(22) PCT Filed: Nov. 30, 2023
(86) PCT No.: PCT/JP2023/043004

§ 371 Date: Jun. 2, 2025

(30) Foreign Application Priority Data
Dec. 6, 2022 (JP) 2022-195036

(51) Int. Cl. A24F 40/46; A45D 40/24

(52) U.S. Cl. CPC A24F 40/46; A45D 40/24

(57) ABSTRACT

The present disclosure provides a cosmetic-component atomization apparatus that is provided in a cosmetic device and can stably and appropriately supply a cosmetic component. The cosmetic-component atomization apparatus according to the present disclosure is a cosmetic-component atomization apparatus that is provided in an atomization device or a cosmetic device to eject mist and is configured to atomize and diffuse a cosmetic component into the air. A cosmetic-component atomization apparatus includes a cosmetic component that is solid or semi-solid at room temperature, a carrier that carries cosmetic component, and an atomizer which is brought close to at least one of the cosmetic component or the carrier and heat the cosmetic component to a temperature equal to or more than a melting point or a sublimation point of the cosmetic component to atomize the cosmetic component.

### TECHNICAL FIELD

The present disclosure relates to a cosmetic-component atomization apparatus and a cosmetic device.

### BACKGROUND ART

Conventionally, a cosmetic device for supplying a cosmetic component to hair in an air flow has been proposed. PTL 1 discloses a hair dryer that diffuses an air flow containing a cosmetic component. The hair dryer disclosed in PTL 1 includes a holding member for holding a cosmetic component. In the hair dryer disclosed in PTL 1, the cosmetic component is dissolved in droplets, and then the droplets are blown out from the outlet of the hair dryer. In this way, the cosmetic component is supplied to the hair and scalp of a user.

### CITATION LIST

### Patent Literature

PTL 1: Unexamined Japanese Patent Publication No. 2019-111152

### SUMMARY OF THE INVENTION

### Technical Problem

In the hair dryer disclosed in PTL 1, a cosmetic component is discharged into an air flow using, as a medium, a mist generated by misting droplets with an atomization apparatus. Therefore, the hair dryer fails to discharge a cosmetic component that is not soluble in the misted droplets. In addition, the droplets for discharging the cosmetic component are liquid, and thus it is difficult to storage the droplets and to stably supply the droplets to the atomization apparatus.

The present disclosure has been made in view of such a problem of the conventional technique. An object of the present disclosure is to provide a cosmetic-component atomization apparatus that is provided in a cosmetic device and can stably and appropriately supply a cosmetic component.

### Solution to Problem

A cosmetic-component atomization apparatus according to an aspect of the present disclosure is a cosmetic-component atomization apparatus for atomizing a cosmetic component and diffusing the cosmetic component into air. The cosmetic-component atomization apparatus is configured to be provided for an atomization device or a cosmetic device configured to eject mist. The cosmetic-component atomization apparatus comprises the cosmetic component that is solid or semi-solid at normal temperature; a carrier configured to carry the cosmetic component; and an atomizer configured to be brought close to at least one of the cosmetic component or the carrier and heat the cosmetic component to a temperature equal to or more than a melting point or a sublimation point of the cosmetic component to atomize the cosmetic component.

A cosmetic-component atomization apparatus according to another aspect of the present disclosure is a cosmetic-component atomization apparatus for atomizing at least one cosmetic component and diffusing the cosmetic component into air. The cosmetic-component atomization apparatus is configured to be provided for an atomization device or a cosmetic device configured to eject mist. The cosmetic-component atomization apparatus comprises at least one carrier configured to carry the cosmetic component that is solid or semi-solid at normal temperature; and an atomizer configured to be brought close to at least one of the cosmetic component or the carrier and heat the cosmetic component to a temperature equal to or more than a melting point or a sublimation point of the cosmetic component to atomize the cosmetic component.

A cosmetic device according to another aspect of the present disclosure includes the cosmetic-component atomization apparatus.

### Advantageous Effect of Invention

The present disclosure can provide a cosmetic-component atomization apparatus that is provided in a cosmetic device and can stably and appropriately supply a cosmetic component.

### BRIEF DESCRIPTION OF THE DRAWINGS

FIG. 1 is a view showing an appearance of a hair dryer to which a cosmetic-component atomization apparatus according to a first exemplary embodiment is applied.

FIG. 2 is a cross-sectional view showing the hair dryer to which the cosmetic-component atomization apparatus according to the first exemplary embodiment is applied.

FIG. 3 is a view for describing a configuration of the cosmetic-component atomization apparatus according to the first exemplary embodiment.

FIG. 4A is a view for describing a cosmetic component according to the first exemplary embodiment.

FIG. 4B is a view for describing a cosmetic component according to the first exemplary embodiment.

FIG. 4C is a view for describing a cosmetic component according to the first exemplary embodiment.

FIG. 5A is a view for describing the cosmetic-component atomization apparatus according to the first exemplary embodiment.

FIG. 5B is a view for describing the cosmetic-component atomization apparatus according to the first exemplary embodiment.

FIG. 6 is a view for describing attachment of a cosmetic component in the cosmetic-component atomization apparatus according to the first exemplary embodiment.

FIG. 7A is a view for describing the cosmetic-component atomization apparatus according to the first exemplary embodiment.

FIG. 7B is a view for describing the cosmetic-component atomization apparatus according to the first exemplary embodiment.

FIG. 7C is a view for describing the cosmetic-component atomization apparatus according to the first exemplary embodiment.

FIG. 8A is a view for describing the cosmetic-component atomization apparatus according to the first exemplary embodiment.

FIG. 8B is a view for describing the cosmetic-component atomization apparatus according to the first exemplary embodiment.

FIG. 8C is a view for describing the cosmetic-component atomization apparatus according to the first exemplary embodiment.

FIG. 9A is a view for describing the cosmetic-component atomization apparatus according to the first exemplary embodiment.

FIG. 9B is a view for describing the cosmetic-component atomization apparatus according to the first exemplary embodiment.

FIG. 9C is a view for describing the cosmetic-component atomization apparatus according to the first exemplary embodiment.

FIG. 9D is a view for describing the cosmetic-component atomization apparatus according to the first exemplary embodiment.

FIG. 10A is a view showing a relationship between a distance from a cosmetic component to an atomizer and a cosmetic component temperature.

FIG. 10B is a view showing a relationship between a cosmetic component temperature and an atomization amount of the cosmetic component.

FIG. 11A is a block diagram showing a configuration of a control device according to a second exemplary embodiment.

FIG. 11B is a block diagram showing a functional configuration of the control device according to the second exemplary embodiment.

FIG. 12A is a view for describing a cosmetic-component atomization apparatus according to the second exemplary embodiment.

FIG. 12B is a view for describing the cosmetic-component atomization apparatus according to the second exemplary embodiment.

FIG. 13A is a view for describing the cosmetic-component atomization apparatus according to the second exemplary embodiment.

FIG. 13B is a view for describing the cosmetic-component atomization apparatus according to the second exemplary embodiment.

FIG. 14A is a view for describing the cosmetic-component atomization apparatus according to the second exemplary embodiment.

FIG. 14B is a view for describing the cosmetic-component atomization apparatus according to the second exemplary embodiment.

FIG. 15A is a view for describing the cosmetic-component atomization apparatus according to the second exemplary embodiment.

FIG. 15B is a view for describing the cosmetic-component atomization apparatus according to the second exemplary embodiment.

FIG. 15C is a view for describing the cosmetic-component atomization apparatus according to the second exemplary embodiment.

FIG. 15D is a view for describing the cosmetic-component atomization apparatus according to the second exemplary embodiment.

FIG. 16A is a view for describing the cosmetic-component atomization apparatus according to the second exemplary embodiment.

FIG. 16B is a view for describing the cosmetic-component atomization apparatus according to the second exemplary embodiment.

FIG. 17 is a view for describing a relationship between an atomization time and an atomization amount of a cosmetic component.

FIG. 18 is a view for describing a relationship between an atomization time and an atomization amount of a cosmetic component.

FIG. 19 is a view for describing the cosmetic-component atomization apparatus according to the second exemplary embodiment.

FIG. 20 is a view for describing a relationship between a feed speed and an atomization amount of a cosmetic component in the second exemplary embodiment.

FIG. 21A is a view for describing the cosmetic-component atomization apparatus according to the second exemplary embodiment.

FIG. 21B is a view for describing the cosmetic-component atomization apparatus according to the second exemplary embodiment.

FIG. 22 is a view for describing a relationship between a heat area and an atomization amount of a cosmetic component.

FIG. 23A is a view for describing the cosmetic-component atomization apparatus according to the second exemplary embodiment.

FIG. 23B is a view for describing the cosmetic-component atomization apparatus according to the second exemplary embodiment.

FIG. 24A is a view for explaining a heat treatment of the cosmetic-component atomization apparatus according to the second exemplary embodiment.

FIG. 24B is a view for explaining the heat treatment of the cosmetic-component atomization apparatus according to the second exemplary embodiment.

FIG. 25A is a view for describing a cosmetic component in the cosmetic-component atomization apparatus according to a third exemplary embodiment.

FIG. 25B is a view for describing the cosmetic component in the cosmetic-component atomization apparatus according to the third exemplary embodiment.

FIG. 25C is a view for describing the cosmetic component in the cosmetic-component atomization apparatus according to the third exemplary embodiment.

FIG. 26A is a view for describing the cosmetic component in the cosmetic-component atomization apparatus according to a third exemplary embodiment.

FIG. 26B is a view for describing the cosmetic component in the cosmetic-component atomization apparatus according to the third exemplary embodiment.

FIG. 26C is a view for describing the cosmetic component in the cosmetic-component atomization apparatus according to the third exemplary embodiment.

FIG. 27A is a view for describing the cosmetic component in the cosmetic-component atomization apparatus according to a third exemplary embodiment.

FIG. 27B is a view for describing the cosmetic component in the cosmetic-component atomization apparatus according to the third exemplary embodiment.

FIG. 28A is a view for describing a configuration of a carrier according to another exemplary embodiment.

FIG. 28B is a view for describing the configuration of the carrier according to another exemplary embodiment.

FIG. 28C is a view for describing the configuration of the carrier according to another exemplary embodiment.

FIG. 29 is a view for describing cosmetic component transfer according to another exemplary embodiment.

FIG. 30 is a view for describing a cosmetic device according to another exemplary embodiment.

FIG. 31 is a view for describing an example of a case where the cosmetic device according to another exemplary embodiment is applied to a hair iron.

FIG. 32A is a view for describing an example of a case where the cosmetic device according to another exemplary embodiment is applied to a hair brush.

FIG. 32B is a view for describing the example of the case where the cosmetic device according to another exemplary embodiment is applied to the hair brush.

FIG. 33 is a view for describing an example of a case where the cosmetic device according to another exemplary embodiment is applied to a facial care device.

FIG. 34 is a view for describing an example in a case where the cosmetic device according to another exemplary embodiment is applied to a steamer.

### DESCRIPTION OF EMBODIMENT

Exemplary embodiments are described below in detail with reference to the drawings. It is noted that a more detailed description than need may be omitted. For example, a detailed description of a well-known matter or a repeated description of substantially the same configuration may be omitted. The accompanying drawings and the following description are provided for those skilled in the art to fully understand the present disclosure, and are not intended to limit the subject matter described in the claims.

### First Exemplary Embodiment

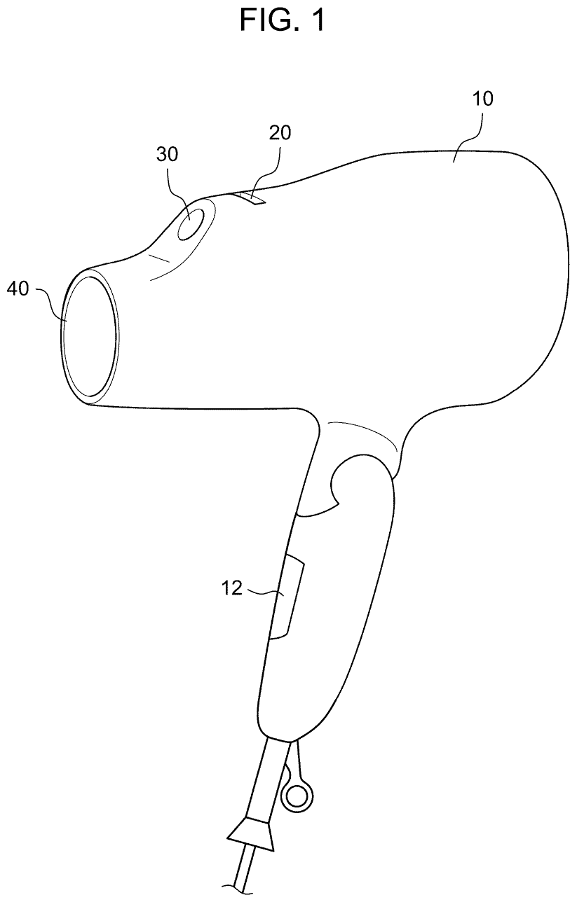

Cosmetic-component atomization apparatus 100 is provided in cosmetic device 10, and atomizes and diffuses cosmetic component 110 into air. FIG. 1 shows a view of an appearance of a hair dryer, which is cosmetic device 10, provided with cosmetic-component atomization apparatus 100 according to the first exemplary embodiment. As shown in FIG. 1, cosmetic device 10 includes switch 12, cosmetic component insertion port 20, cosmetic component discharge port 30, and hot air discharge port 40.

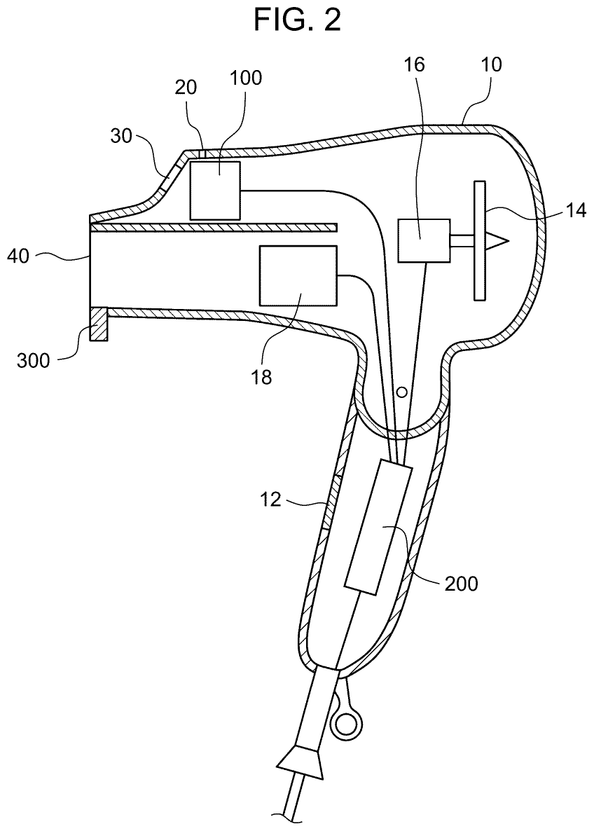

FIG. 2 is a schematic cross-sectional view for describing an internal structure of cosmetic device 10 shown in FIG. 1. As shown in FIG. 2, the hair dryer as cosmetic device 10 includes fan 14, fan motor 16, heater 18, and cosmetic-component atomization apparatus 100. In addition, cosmetic-component atomization apparatus 100 may include control device 200 and detector 300. A configuration of cosmetic-component atomization apparatus 100 including control device 200 or detector 300 will be described later.

Cosmetic device 10 is activated by pressing switch 12, and fan motor 16 is driven based on control of control device 200. In addition, fan 14 is rotated by the driving of fan motor 16, and an air flow is discharged from cosmetic component discharge port 30 and hot air discharge port 40. In addition, cosmetic device 10 as a hair dryer includes heater 18 that operates based on the control of control device 200, and when heater 18 is on, an air flow generated by the rotation of fan 14 is heated by heater 18, and hot air is discharged from hot air discharge port 40.

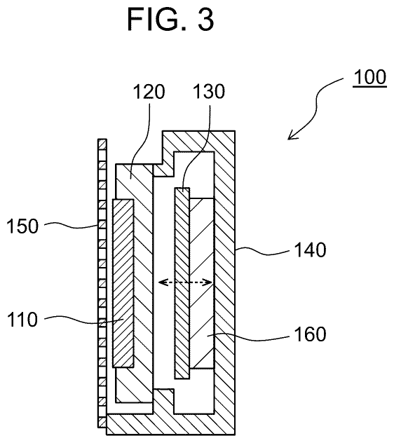

A configuration of cosmetic-component atomization apparatus 100 according to the first exemplary embodiment will be described with reference to FIG. 3. FIG. 3 is a schematic cross-sectional view showing a configuration example of cosmetic-component atomization apparatus 100 according to the first exemplary embodiment. As shown in FIG. 3, cosmetic-component atomization apparatus 100 includes cosmetic component 110, carrier 120, atomizer 130, housing 140, lid 150, and driver 160.

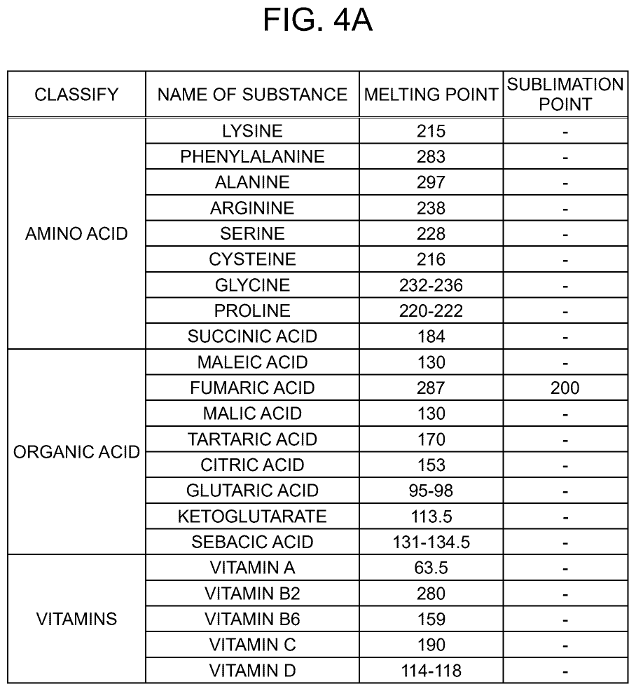

Cosmetic component 110 applied in the first exemplary embodiment is a solid or semi-solid substance at room temperature. In the first exemplary embodiment, the semi-solid is a substance that is carried on carrier 120 and can remain on carrier 120 without dripping. FIGS. 4A to 4C are views showing a list of cosmetic components. FIG. 4A shows substance names, melting points, and sublimation points of amino acids, organic acids, and vitamin acids used as cosmetic components. In addition, FIG. 4B shows substance names, melting points, and sublimation points of metals, antioxidant components, hormones, ceramides, peptides, and others used as cosmetic components. Further, FIG. 4C shows substance names, melting points, and sublimation points of lipids, saccharides, and fats and oils used as cosmetic components.

The cosmetic component applied to cosmetic-component atomization apparatus 100 according to the present exemplary embodiment is a cosmetic component having a vapor pressure at a melting point or more, and is preferably a substance having a melting point or a sublimation point at 40° C. or more and having a vapor pressure up to 300° C. The substance having a melting point or a sublimation point at 40° C. or more and a vapor pressure up to 300° C. corresponds to the organic acid shown in FIG. 4A. Further, in cosmetic-component atomization apparatus 100 according to the present exemplary embodiment, it is preferable to apply fumaric acid, malic acid, and sebacic acid among organic acids. In addition, in cosmetic-component atomization apparatus 100 according to the present exemplary embodiment, it is preferable to apply stearic acid and cholesterol that are lipids in addition to organic acids. Cosmetic component 110 applied in the present exemplary embodiment is not limited to the substances shown in FIGS. 4A to 4C as long as cosmetic component 110 is a substance having a vapor pressure at a melting point or more.

Carrier 120 is a member for carrying cosmetic component 110. For example, it is preferable to apply, to carrier 120, a heat-resistant material and chemical-resistant material having a melting point or more and a sublimation point or more of cosmetic component 110. This carrier 120 may be formed of, for example, a material such as a yarn, a heat-resistant fiber, a woven fabric, a nonwoven fabric, a mat, a film, a plate, glass, a heat-resistant paper, a metal, or a perforated silicon sheet having a minute opening. In addition, carrier 120 may be configured to be replaceable by a user. This makes it possible to provide cosmetic-component atomization apparatus 100 with carrier 120, for example, suitably depending on the melting point and sublimation point of cosmetic component 110.

In addition, a component of carrier 120 may be paper, acrylic fiber, polyphenylene sulfide (PPS) fiber, polybutylene terephthalate (PBT) fiber, metal, ceramic fiber, or a porous body (e.g., zeolite, activated carbon, or foamed polyimide). In addition, a component of carrier 120 may be glass fiber, metal fiber or metal porous body (cermet), resin bead (e.g., ion exchange resin for up to 80° C.), and plant fiber (e.g., cotton or cellulose). Further, the component of carrier 120 may be a chemical fiber of a heat-resistant polymer material such as a polyparaphenylene benzoxazole (PBO) fiber, an aramid fiber, or a polyarylate fiber. In addition, in the present exemplary embodiment, carrier 120 carries cosmetic component 110 using a method such as an impregnation method, a papermaking method, a spray method, or microcoating.

Atomizer 130 is a member for heating cosmetic component 110 or carrier 120 brought close to the atomizer. In the present exemplary embodiment, atomizer 130 may be composed of, for example, an electric wire heater, an induction heater (IH), or a ceramic heater. In addition, atomizer 130 may be composed of hot air, a combination of high frequency or microwave and a heating aid (metal), far infrared rays, ultraviolet rays, or a laser (ultraviolet, argon, YAG, and others). In addition, atomizer 130 may be composed of a combination of a laser and a heating aid, light concentration, electrical discharge (e.g., corona, arc, or plasma), or an ultrasonic wave. Hereinafter, in the present specification, when the member of atomizer 130 is not particularly described, an example in which atomizer 130 includes an electric wire heater will be described.

In addition, in the example shown in FIG. 3, housing 140 is a member for fixing atomizer 130 and driver 160. In addition, housing 140 supports carrier 120. In addition, housing 140 is connected to a part of lid 150. Lid 150 has holes through which an air flow passes, and from the holes, atomized cosmetic component 110 is diffused.

Driver 160 has a function of supporting atomizer 130 and adjusting the position of atomizer 130. In the first exemplary embodiment, cosmetic-component atomization apparatus 100 does not have to include driver 160 in the configuration in which the position of atomizer 130 does not need to be adjusted.

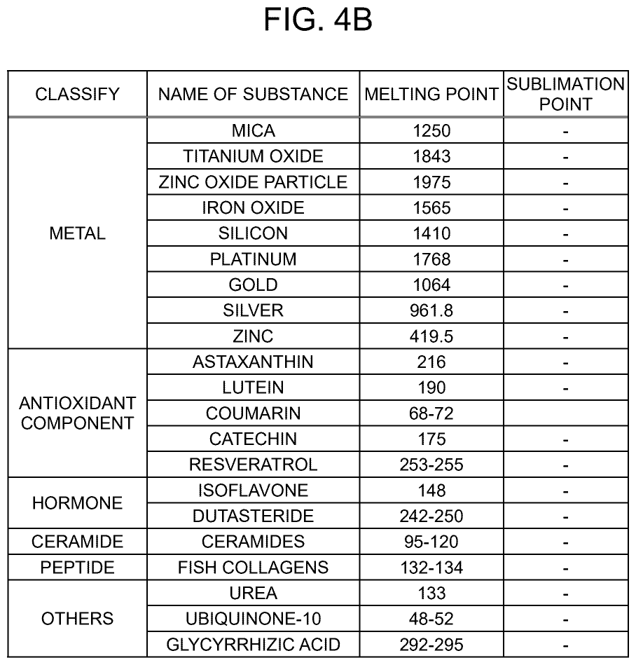

FIGS. 5A and 5B are views showing a configuration in a case where driver 160 is not provided. As shown in FIG. 5A, cosmetic component 110 carried by carrier 120 is inserted into cosmetic-component atomization apparatus 100 by a user in a state where lid 150 is opened.

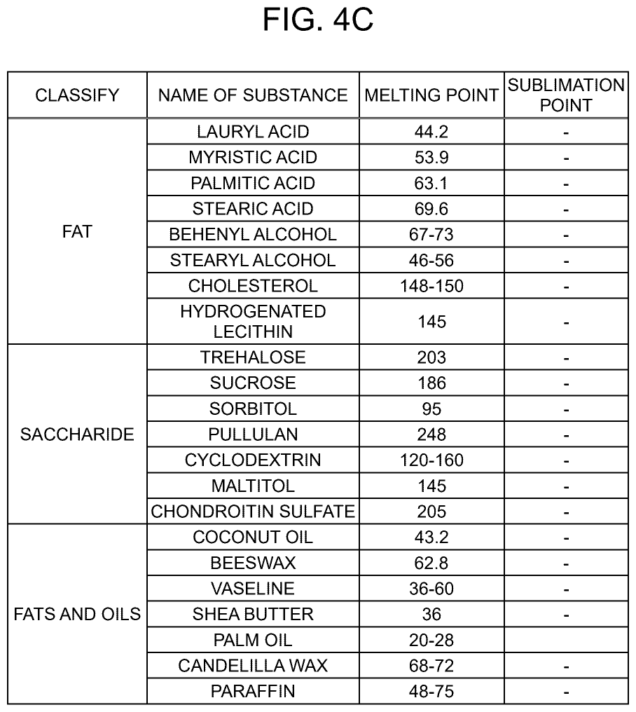

FIG. 6 shows an example of a case where cosmetic component 110 is inserted into cosmetic-component atomization apparatus 100 by a user. For example, in the example shown in FIG. 6, the user opens lid 150 connected to housing 140, and inserts cosmetic component 110 carried by carrier 120 into cosmetic-component atomization apparatus 100. The holes for allowing an air flow to pass through the lid 150 are not shown in FIG. 6.

As shown in FIG. 5B, in a state where lid 150 is closed, cosmetic component 110 carried by carrier 120 is incorporated in cosmetic device 10, and is supported by housing 140 and atomizer 130. Heating atomizer 130 causes carrier 120 and cosmetic component 110 to be heated, thereby atomizing cosmetic component 110 that has reached the melting point or the sublimation point, and the atomized cosmetic component is diffused into the air. In FIG. 5B, the atomized cosmetic component is indicated by cosmetic component 111. Hereinafter, in the present specification, the “atomized cosmetic component” is referred to as cosmetic component 111, and when it is not necessary to distinguish between before and after atomization, the cosmetic component is referred to as cosmetic component 110.

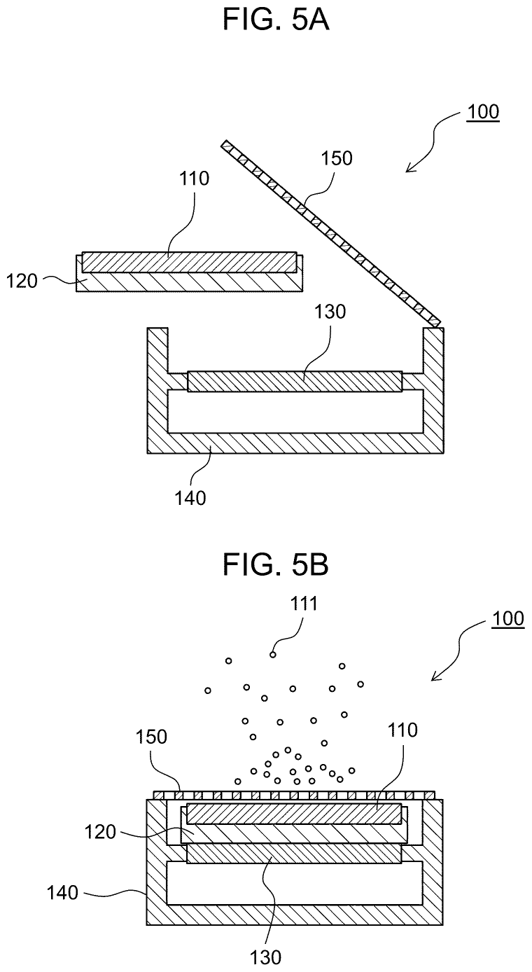

Then, cosmetic-component atomization apparatus 100 including driver 160 will be described with reference to FIGS. 7A to 7C. Similarly to the example shown in FIG. 5A, FIG. 7A shows an example of a case where the user inserts cosmetic component 110 carried by carrier 120 into housing 140 in a state where lid 150 is opened.

FIG. 7B shows a state in which cosmetic component 110 carried by carrier 120 is supported inside housing 140. In addition, in FIG. 7B, lid 150 is closed by the user.

FIG. 7C shows an example of a case where the position of atomizer 130 is adjusted by driver 160, and where heating carrier 120 and cosmetic component 110 are heated due to the heat of causes atomizer 130, thereby atomizing cosmetic component 110 that has reached the melting point or the sublimation point and diffusing into the air. Specifically, as shown in FIG. 7C, driver 160 drives atomizer 130 to bring atomizer 130 and cosmetic component 110 close to each other by a predetermined distance. In the present exemplary embodiment, the predetermined distance is a distance at which an appropriate atomization amount of cosmetic component 110 is atomized by heating atomizer 130. In addition, the predetermined distance includes a distance at which atomizer 130 and cosmetic component 110 are in contact with each other.

Driver 160 may be configured such that the user presses a button (not shown) provided outside housing 140 in the state of FIG. 7B and the pressing generates a force, which extends driver 160, causing the position of atomizer 130 to be changed to the state shown in FIG. 7C. Alternatively, driver 160 may be configured such that driver 160 is composed of a screw mechanism, and in the state of FIG. 7B, the user rotates a rotary knob (not shown) provided outside housing 140, which extends driver 160, causing the position of the atomizer 130 to be changed to the state shown in FIG. 7C.

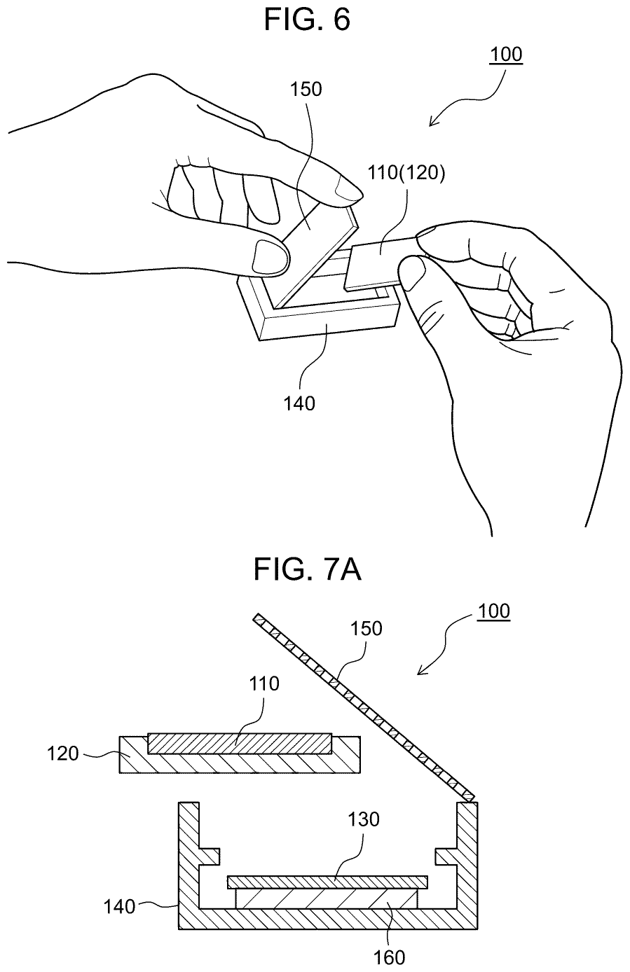

Then, a configuration example in a case where driver 160 includes grip 162 will be described with reference to FIGS. 8A to 8C.

FIG. 8A shows an example of a case where the user attaches cosmetic component 110 carried by carrier 120 to grip 162 provided in driver 160 in a state where lid 150 is opened. In the example shown in FIG. 8A, cosmetic component 110 is carried on the lower side of carrier 120 in the figure.

FIG. 8B shows a state in which carrier 120 and cosmetic component 110 carried by carrier 120 are gripped by grip 162 of driver 160, and a state in which lid 150 is closed.

FIG. 8C shows a state in which driver 160 is driven to bring cosmetic component 110 into contact with atomizer 130. Similarly to the configuration shown in FIG. 7C, driver 160 in FIG. 8C may be configured such that the user presses a button (not shown) provided outside housing 140 or rotates a rotary knob (not shown) to extend driver 160, thereby bringing cosmetic component 110 into contact with atomizer 130. In addition, the example of FIG. 8C shows an example of a case where cosmetic component 110 is heated by heating atomizer 130, thereby atomizing cosmetic component 110 that has reached the melting point or the sublimation point and diffusing in the air.

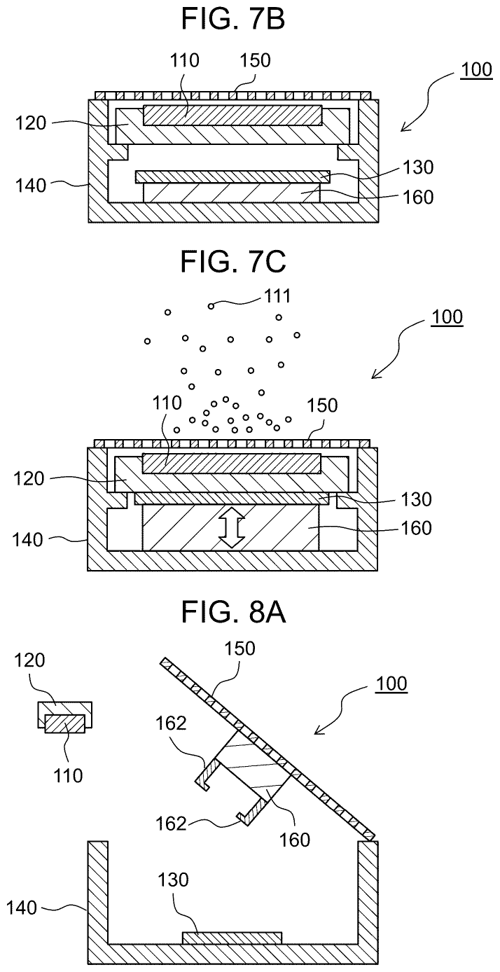

Then, a configuration in which only cosmetic component 110 is brought into direct contact with atomizer 130 will be described with reference to FIGS. 9A to 9D.

In the examples shown in FIGS. 9A to 9C, similarly to the examples shown in FIGS. 8A to 8C, the user causes cosmetic component 110 carried by carrier 120 to be gripped in grip 162 of driver 160, closes lid 150, and brings cosmetic component 110 into contact with atomizer 130.

FIG. 9D shows an example of a case where the user presses a button (not shown) provided outside housing 140 or rotates a rotary knob (not shown) to contract driver 160. In the example shown in FIG. 9D, there may be used a configuration in which driver 160 may be contracted after a predetermined time has elapsed from the start of heating atomizer 130, whereby only cosmetic component 110 remains on the upper surface of atomizer 130. In addition, the example of FIG. 9D shows an example of a case where cosmetic component 110 is heated by heating atomizer 130, thereby atomizing cosmetic component 110 that has reached the melting point or the sublimation point and diffusing in the air.

As described above, using the configuration in which only cosmetic component 110 is brought into contact with atomizer 130 and in which carrier 120 is separated from atomizer 130, carrier 120 can be formed of a substance susceptible to heating, allowing the easiness of selection of the material of carrier 120 to be improved.

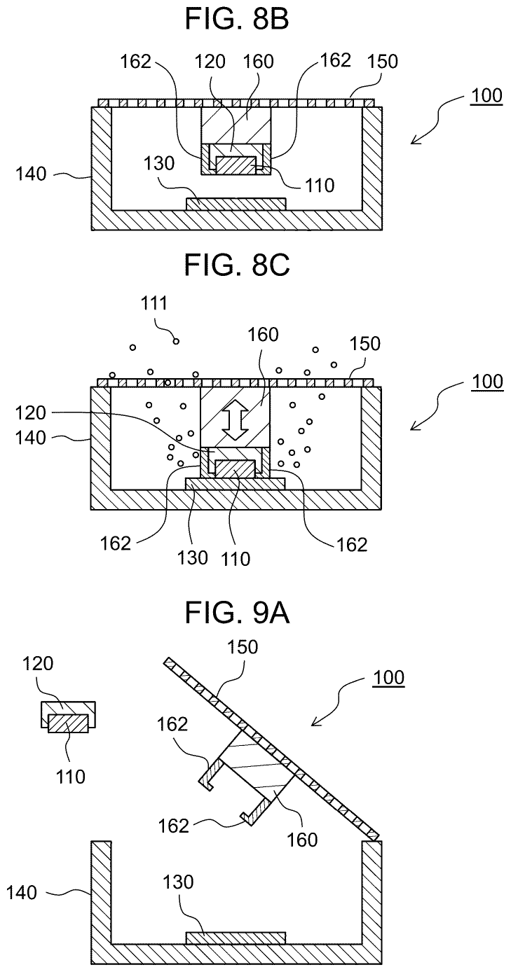

Then, characteristics of a temperature and an atomization amount of cosmetic component 110 with respect to a distance from cosmetic component 110 to atomizer 130 will be described with reference to FIGS. 10A and 10B.

FIG. 10A is a view showing a relationship between a distance from atomizer 130 to cosmetic component 110 or carrier 120 and a cosmetic component temperature. As shown in FIG. 10A, as the distance from atomizer 130 to cosmetic component 110 or carrier 120 is shorter, the cosmetic component temperature becomes higher. As the distance from atomizer 130 to cosmetic component 110 or carrier 120 is longer, the cosmetic component temperature becomes lower.

In addition, FIG. 10B is a view showing a relationship between the temperature of cosmetic component 110 and the atomization amount Y of the cosmetic component. As shown in FIG. 10B, as the temperature of cosmetic component 110 increases, the atomization amount Y of the cosmetic component increases. That is, as shown in FIG. 10A and FIG. 10B, as the distance from atomizer 130 to cosmetic component 110 is shorter, the temperature of cosmetic component 110 becomes higher, and the atomization amount of cosmetic component 110 increases.

As described above, cosmetic-component atomization apparatus 100 according to the first exemplary embodiment is a cosmetic-component atomization apparatus that is provided in a cosmetic device and is configured to atomize and diffuse a cosmetic component into the air. Cosmetic-component atomization apparatus 100 includes cosmetic component 110 that is solid or semi-solid at room temperature, and carrier 120 for carrying cosmetic component 110. In addition, cosmetic-component atomization apparatus 100 includes atomizer 130 that is brought close to cosmetic component 110 or carrier 120 to heat and atomize cosmetic component 110 to a temperature equal to or more than a melting point or a sublimation point of cosmetic component 110.

Thus, in cosmetic-component atomization apparatus 100, cosmetic component 110 that is solid or semi-solid at normal temperature is carried by carrier 120 and is brought close to atomizer 130, which is then heated to atomize cosmetic component 110. Thus, using solid or semi-solid cosmetic component 110, cosmetic-component atomization apparatus 100 can apply cosmetic component 110 that is hardly oxidized, can be stored for a long period of time, and does not drip like a droplet in the apparatus. In addition, cosmetic-component atomization apparatus 100 is applicable to hydrophobic solid or semi-solid cosmetic component 110. Therefore, cosmetic-component atomization apparatus 100 is provided in cosmetic device 10, and can stably and appropriately supply cosmetic component 110.

In addition, cosmetic-component atomization apparatus 100 includes driver 160 that drives atomizer 130 to bring atomizer 130 and cosmetic component 110 close to each other by a predetermined distance. Thus, cosmetic-component atomization apparatus 100 can atomize cosmetic component 110 appropriately depending on properties such as a melting point of cosmetic component 110. In the present exemplary embodiment, the predetermined distance is a distance at which an appropriate atomization amount of cosmetic component 110 is atomized by heating atomizer 130. In addition, in the present exemplary embodiment, the predetermined distance includes a distance at which atomizer 130 and cosmetic component 110 are in contact with each other.

### Second Exemplary Embodiment

As described above, although one specific exemplary embodiment has been described, the above-described exemplary embodiment is an example and does not limit the exemplary embodiment. For example, in the exemplary embodiment described above, atomizer 130 brought close to cosmetic component 110 is heated to diffuse atomized cosmetic component 111 into the air. Herein, for cosmetic-component atomization apparatus 100 according to the second exemplary embodiment that controls atomizer 130 and other mechanisms by using control device 200, the configuration different from the first exemplary embodiment will be described.

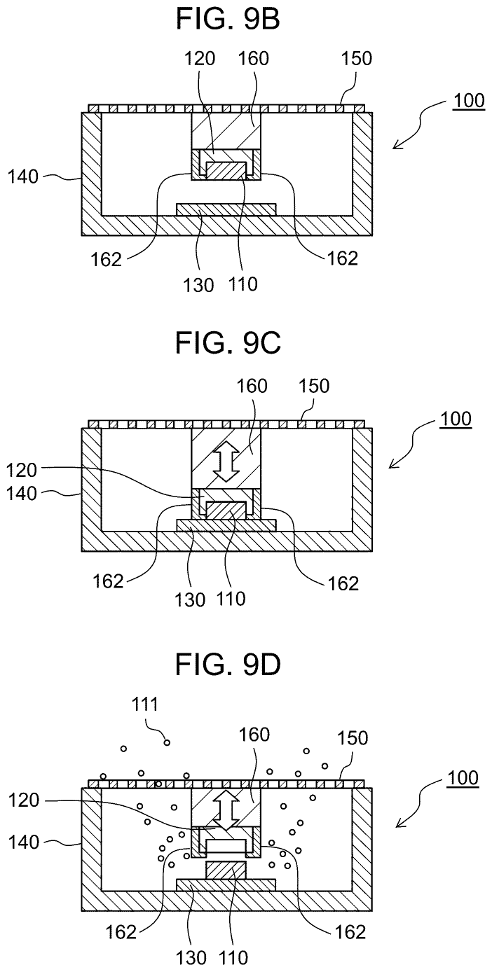

FIG. 11A is a block view showing a configuration of control device 200. As shown in FIG. 11A, control device 200 includes controller 210, storage unit 220, and input/output interface 230 (hereinafter, referred to as IF). In addition, control device 200 may include communication IF 240. That is, in the present exemplary embodiment, control device 200 is composed of a general microcomputer including controller 210, storage unit 220, and input/output IF 230.

In the present exemplary embodiment, there is shown an example in which a plurality of information processing functions included in control device 200 are achieved by software. Control device 200 functions as a plurality of information processing circuits included in control device 200 by executing a computer program.

In addition, as another configuration, by preparing dedicated hardware for executing each piece of information processing shown in FIG. 11B, control device 200 can configure the information processing function by using a system large scale integration (hereinafter, referred to as LSI). In addition, a plurality of information processing functions may be configured by individual hardware. Details of controller 210 and storage unit 220 included in control device 200 will be described later.

Input/output IF 230 is an interface for transmitting and receiving information (data) exchanged between control device 200 and each device such as cosmetic-component atomization apparatus 100, fan motor 16, and heater 18 in cosmetic device 10.

Communication IF 240 is an interface for communicating with the outside of control device 200 via a wireless network. For example, when various programs of control device 200 are updated, the update data may be downloaded.

Then, a functional configuration of cosmetic-component atomization apparatus 100 according to the present exemplary embodiment will be described with reference to FIG. 11B. As shown in FIG. 11B, controller 210 includes, as functions, heating controller 211, drive controller 212, mechanism controller 213, carrier controller 214, state detector 215, user detector 216, cosmetic component transfer unit 217, and cosmetic component selector 218. Details of each function in controller 210 will be described later.

In addition, controller 210 operates an operating system to control entire cosmetic device 10, for example. Further, controller 210 operates on the basis of the program stored in storage unit 220, and executes each function described above. The program is not limited to the form stored in storage unit 220, and may be configured to be stored in, for example, a read only memory (ROM) or the like (not shown) in cosmetic device 10.

As shown in FIG. 11B, storage unit 220 stores, as data, information included in user information DB 221 (here, DB: Database), cosmetic component information DB 222, and setting information DB 223. One or a plurality of storage units 220 may store each of these pieces of data. For example, one storage unit 220 may be configured to separate regions for storage. Alternatively, data may be distributed and stored in a plurality of storage devices provided at physically separated places.

Heating controller 211 controls on/off of heating of atomizer 130 and a heating temperature. In addition, heating controller 211 controls on/off of heating of heater 18 and a heating temperature. In addition, heating controller 211 may control an area in which cosmetic component 110 is atomized by atomizer 130.

Drive controller 212 controls the position of driver 160. Specifically, drive controller 212 controls a distance from cosmetic component 110 or carrier 120 to atomizer 130.

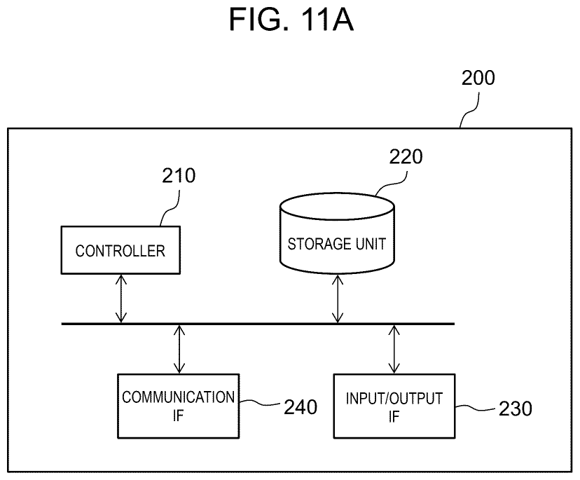

Mechanism controller 213 controls operation of a mechanism provided in cosmetic device 10 such as feed mechanism 170a (refer to FIG. 13A) and wind mechanism 170b (refer to FIG. 13A), which will be described later. Specifically, mechanism controller 213 controls the feed speed, the feed direction, or the feed timing of feed mechanism 170a and wind mechanism 170b. In addition, mechanism controller 213 may control an operation of a mechanism such as fan motor 16 of cosmetic device 10.

Carrier controller 214 controls carrier 120. Specifically, the carrier controller 214 is used when cosmetic component 110 carried by carrier 120 is transferred to atomizer 130.

State detector 215 has a function of detecting at least one state of a skin state or a hair state of a user. In addition, state detector 215 may detect the temperature of cosmetic component 110. Further, state detector 215 may detect an atomization amount of atomized cosmetic component 110. In addition, state detector 215 may detect the state of the at least one state of a skin state or hair state of the user by detecting the moisture amount, the dryness, the corresponding age, color, shape, or temperature and humidity of the at least one state of a skin state or hair state of the user.

User detector 216 has a function of detecting and specifying a user who uses cosmetic device 10. The information on the user detected by the user detector 216 is stored in user information DB 221. In addition, for the information stored in user information DB 221, the at least one state of a skin state or hair state of the user detected by the above-described state detector 215 are stored in association with the user. For example, drive controller 212 adjusts driver 160 such that the atomization amount becomes appropriate for the user specified by user detector 216, whereby cosmetic-component atomization apparatus 100 can perform atomization appropriately depending on the feature such as the melting point of cosmetic component 110.

Cosmetic component transfer unit 217 has a function of transferring cosmetic component 110 to atomizer 130.

Cosmetic component selector 218 has a function of selecting a cosmetic component to be used in cosmetic-component atomization apparatus 100. Cosmetic component selector 218 selects appropriate cosmetic component 110 based on the information about cosmetic component 110 stored in cosmetic component information DB 222. In cosmetic component information DB 222, for example, information on cosmetic component 110 may be a classification, a substance name, a melting point, and a sublimation point included in FIGS. 4A to 4C. Cosmetic component selector 218 selects the type of cosmetic component 110 on the basis of the state of the user's hair detected by state detector 215, depending on a state in which the cosmetic component is applied to the hair. In addition, cosmetic component selector 218 may select appropriate cosmetic component 110 on the basis of a learned model learned by machine learning. Thus, cosmetic-component atomization apparatus 100 can perform appropriate atomization depending on the state of the hair and skin of the user for cosmetic component 110.

Setting information on cosmetic-component atomization apparatus 100 is stored in setting information DB 223. In the present exemplary embodiment, the setting information may include a temperature of atomizer 130 or a distance from atomizer 130 to cosmetic component 110. In addition, the setting information may include control information of the mechanism.

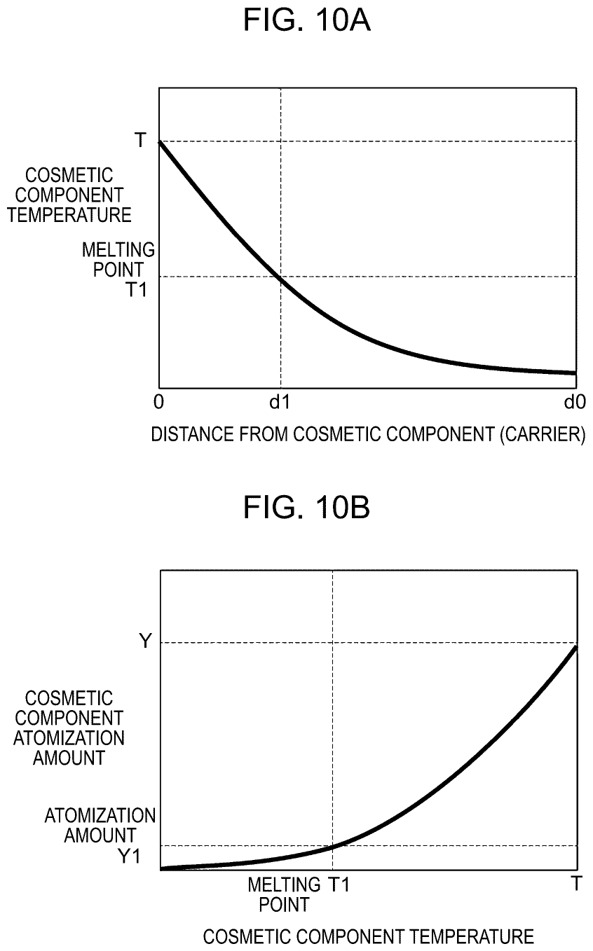

FIGS. 12A and 12B show an example of cosmetic-component atomization apparatus 100 that partially heats atomizer 130 to adjust a heating position of at least one of cosmetic component 110 or carrier 120 to be heated. FIG. 12A shows an example of a case where, as shown in FIG. 5A described above, cosmetic component 110 carried by carrier 120 is inserted into cosmetic-component atomization apparatus 100 by a user in a state where lid 150 is opened. In FIGS. 12A and 12B, a configuration example in a case where driver 160 is not provided is shown, but cosmetic-component atomization apparatus 100 according to the second exemplary embodiment is not limited to this configuration. For example, cosmetic-component atomization apparatus 100 according to the second exemplary embodiment may be configured to include driver 160 in the configurations of FIGS. 12A and 12B.

FIG. 12B shows an example in which control device 200 changes the position of the heat treatment in atomizer 130. In the examples shown in FIGS. 12A and 12B, control device 200 heats atomizer 130a on the left side in the drawing and does not heat remaining atomizer 130b. That is, in the examples shown in FIGS. 12A and 12B, control device 200 adjusts the atomization amount of cosmetic component 110 depending on the heat range of cosmetic component 110 to be heated by atomizer 130. Thus, cosmetic-component atomization apparatus 100 shown in FIGS. 12A and 12B can adjust the atomization amount of cosmetic component 110 to be atomized.

Then, cosmetic-component atomization apparatus 100 including feed mechanism 170a and wind mechanism 170b will be described with reference to FIG. 13A. In cosmetic-component atomization apparatus 100 shown in FIG. 13A, new cosmetic component 110 can be atomized by winding cosmetic component 110 carried by tape-shaped carrier 120 by using feed mechanism 170a and wind mechanism 170b under the control of control device 200. That is, feed mechanism 170a and wind mechanism 170b can move carrier 120 based on a predetermined rule to adjust the atomization amount of cosmetic component 110. Herein, the predetermined rule is, for example, the wind speeds of feed mechanism 170a and wind mechanism 170b controlled by control device 200.

FIG. 13B shows a configuration in which, with respect to the configuration of FIG. 13A, both ends of carrier 120 are fixed by supporter 180, and driver 160 is moved in the left and right direction in the drawing on the basis of the control of control device 200 to adjust the atomization amount of cosmetic component 110. That is, in the configuration shown in FIG. 13B, control device 200 adjusts the atomization amount on the basis of the distance from atomizer 130 to cosmetic component 110 and the heat range of cosmetic component 110 by atomizer 130.

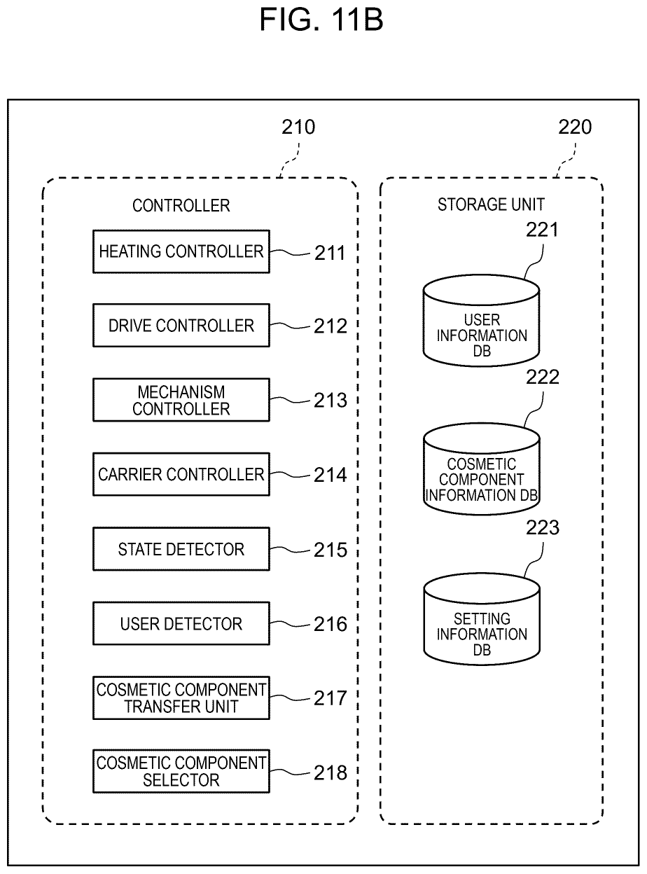

As shown in FIG. 14A, cosmetic-component atomization apparatus 100 may be configured to further include wind supporter 170c with respect to the configuration in FIG. 13A. That is, in FIG. 14A, feed mechanism 170a and wind mechanism 170b can move carrier 120 based on a predetermined rule to adjust the atomization amount of cosmetic component 110. Further, in FIG. 14A, the heat range of cosmetic component 110 close to atomizer 130 can be narrowed as compared with the configuration of FIG. 13A, and the atomization amount of cosmetic component 110 can be adjusted in more detail.

FIG. 14B is a view showing a form of carrier 120 and cosmetic component 110 used in cosmetic-component atomization apparatus 100 in FIG. 14A. As shown in FIG. 14B, cosmetic component 110 is carried on carrier 120 at predetermined intervals, thereby allowing the atomization amount of cosmetic component 110 by heating to be more appropriately adjusted.

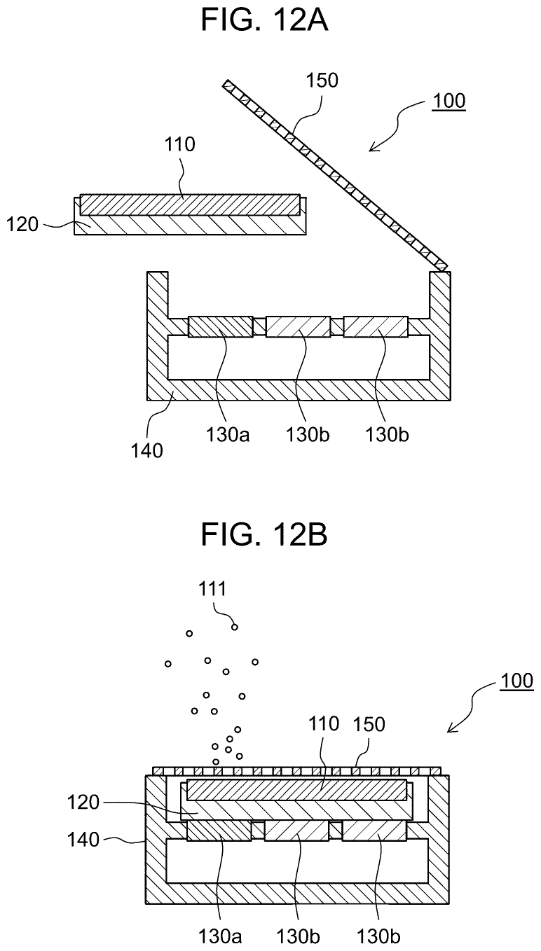

FIGS. 15A to 15D are views for describing a change in heat position 132 of cosmetic component 110 when carrier 120 is moved under the control of control device 200 based on a predetermined rule in FIG. 13A or FIG. 14A.

In the example shown in FIG. 15A, the predetermined rule regarding control from control device 200 moves carrier 120 after stopping for a certain period of time. That is, in the example shown in FIG. 15A, control device 200 stops the movement of carrier 120 for a certain period of time based on a predetermined rule. During this certain period of time, cosmetic component 110 in heat position 132 is atomized. In addition, control device 200 moves carrier 120 after a certain period of time, and stops the movement of carrier 120 again for a certain period of time. Thus, cosmetic-component atomization apparatus 100 shown in FIG. 15A can reliably atomize cosmetic component 110 at heat position 132.

In addition, in the example shown in FIG. 15B, the predetermined rule regarding the control from control device 200 moves carrier 120 at a constant speed. That is, in the example shown in FIG. 15B, control device 200 moves carrier 120 at a constant speed based on a predetermined rule. Thus, cosmetic-component atomization apparatus 100 shown in FIG. 15B can uniformly atomize cosmetic component 110 at heat position 132, and can supply a stable atomization amount.

In the example shown in FIG. 15C, as shown in FIG. 14B, cosmetic component 110 is carried on carrier 120 at predetermined intervals. As described above, carrying cosmetic component 110 on carrier 120 allows the atomization amount of cosmetic component 110 by heating to be more appropriately adjusted. In addition, as shown in FIG. 15D, widening (or narrowing) the interval of cosmetic component 110 carried by carrier 120 allows cosmetic-component atomization apparatus 100 to appropriately adjust the atomization amount of cosmetic component 110.

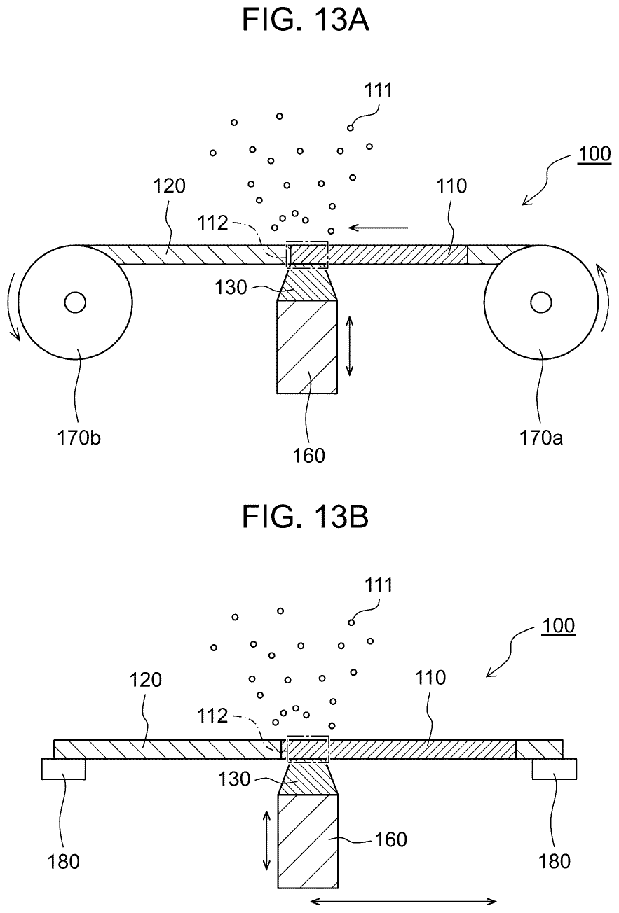

In addition, control device 200 of cosmetic-component atomization apparatus 100 may be configured to move heat position 132 of cosmetic component 110 as shown in FIG. 16A or 16B by controlling an operation of at least one of carrier 120 or atomizer 130. Moving heat position 132 as shown in FIG. 16A allows cosmetic-component atomization apparatus 100 to atomize cosmetic component 110 without waste. In addition, as shown in FIG. 16B, providing an interval (interrupting) between cosmetic components 110 allows cosmetic-component atomization apparatus 100 to provide an appropriate atomization amount without waste of the atomization amount of cosmetic component 110. The movement of heat position 132 to be changed by control device 200 may be, for example, a reciprocating movement, a zigzag movement, a rotational movement, a zigzag movement, or an intermittent movement, in addition to the meandering movement shown in FIGS. 16A and 16B.

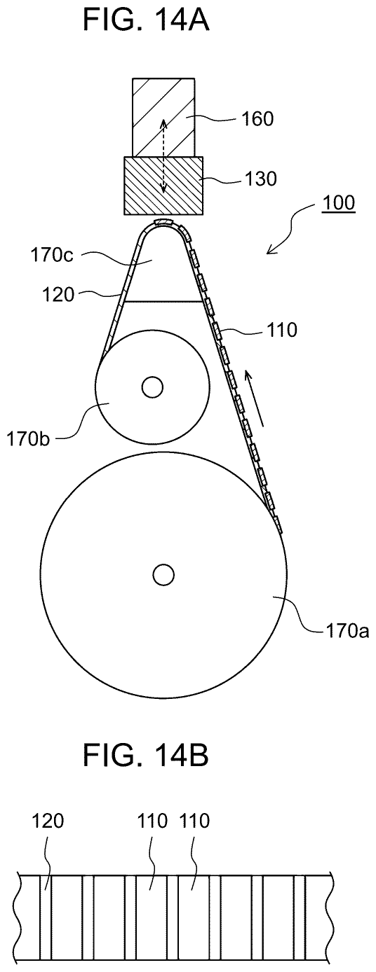

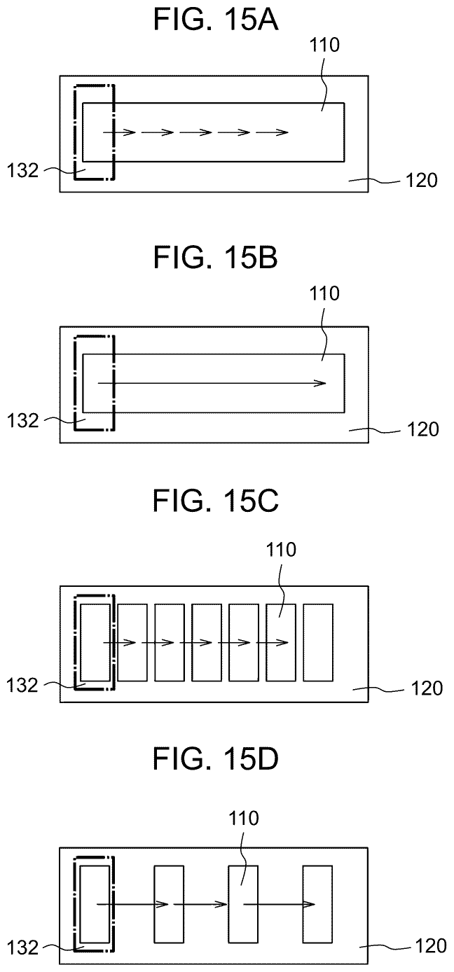

FIGS. 17 and 18 are graphs showing a relationship between a heat time of cosmetic component 110 and an atomization amount of cosmetic component 110 in a configuration in which heat position 132 moves. FIG. 17 is an example of a case where, as shown in FIG. 15A, carrier 120 is moved while being stopped for a certain period of time with respect to the movement of heat position 132. As shown in FIG. 17, when heat position 132 is stopped for a certain period of time, an atomization amount of cosmetic component 110 decreases after a lapse of a predetermined period of time. When heat position 132 is moved after a lapse of a predetermined time t shown in FIG. 17, atomization of cosmetic component 110 is started again and the atomization amount is recovered.

The example shown in FIG. 18 is an example of a case where control device 200 moves carrier 120 at a constant speed based on a predetermined rule as shown in FIG. 15B. As shown in FIG. 18, changing heat position 132 at a constant speed allows uniform atomization of cosmetic component 110 to be achieved.

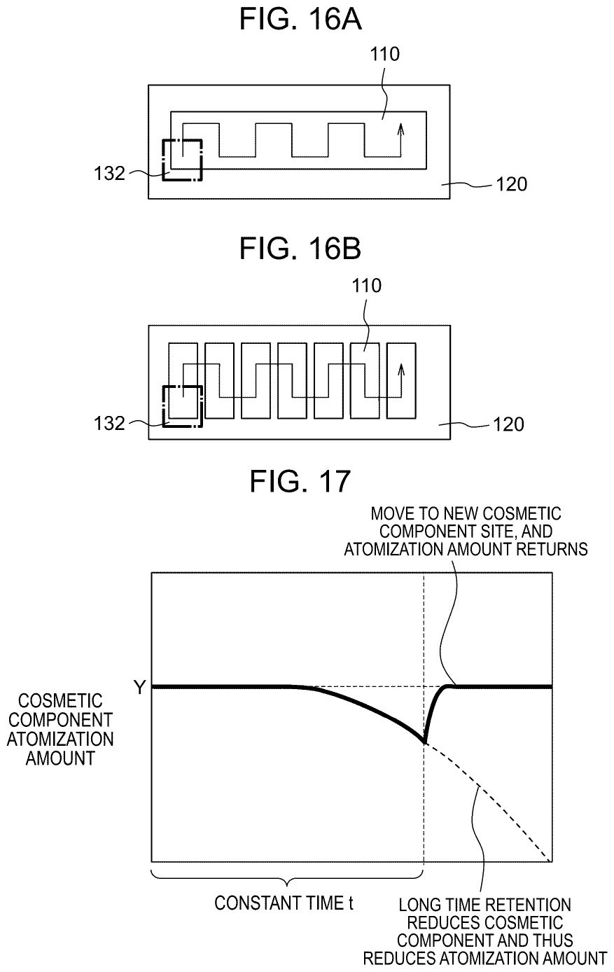

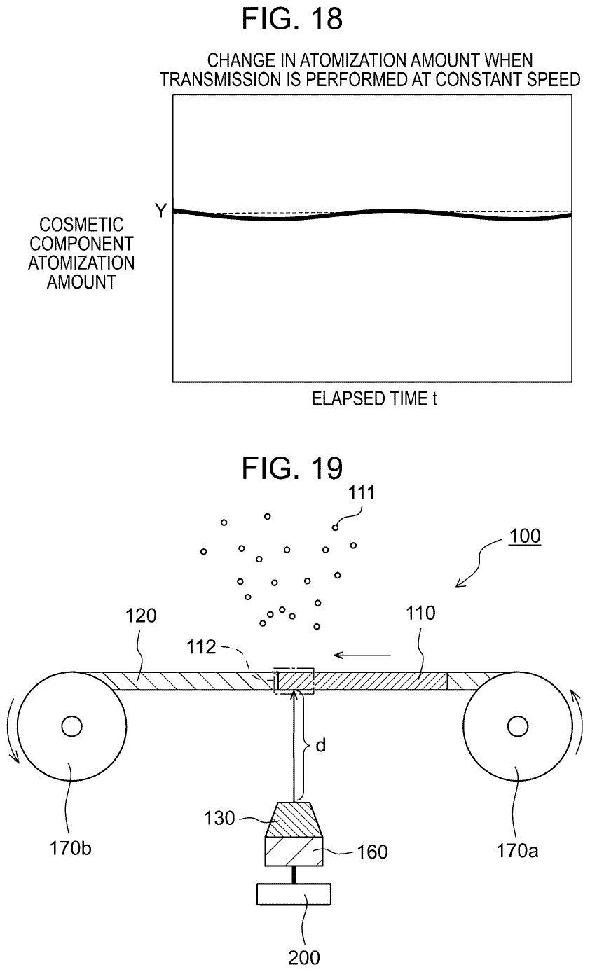

Then, the relationship between the feed speed of feed mechanism 170a and wind mechanism 170b and the atomization amount of cosmetic component 110 will be described with reference to FIGS. 19 and 20. For example, as shown in FIG. 19, driving of driver 160 by control device 200 causes atomizer 130 to be brought close to cosmetic component 110 by distance d, and cosmetic component 110 is wound up at feed speed x. In the relationship between the feed speed x and the atomization amount in heat range 112 in this case, as shown in FIG. 20, the atomization amount of cosmetic component 110 decreases as the feed speed increases. That is, control device 200 of cosmetic-component atomization apparatus 100 adjusts feed speed x of feed mechanism 170a and wind mechanism 170b such that the atomization amount of cosmetic component 110 becomes an appropriate amount. Thus, cosmetic-component atomization apparatus 100 can flexibly adjust the atomization amount of cosmetic component 110 depending on the component and use of cosmetic component 110.

In addition, cosmetic-component atomization apparatus 100 may further include a cosmetic component information storage unit (not shown). For example, the cosmetic component information storage unit may be configured to store features such as a melting point and a sublimation point of cosmetic component 110, and the features may be read by control device 200. In addition, control device 200 may be configured to control the distance from atomizer 130 to cosmetic component 110, the temperature of atomizer 130, or the feed speed of feed mechanism 170a and wind mechanism 170b based on the information stored in the cosmetic component information storage unit. Thus, cosmetic-component atomization apparatus 100 can appropriately adjust the atomization amount of cosmetic component 110 depending on the feature of cosmetic component 110.

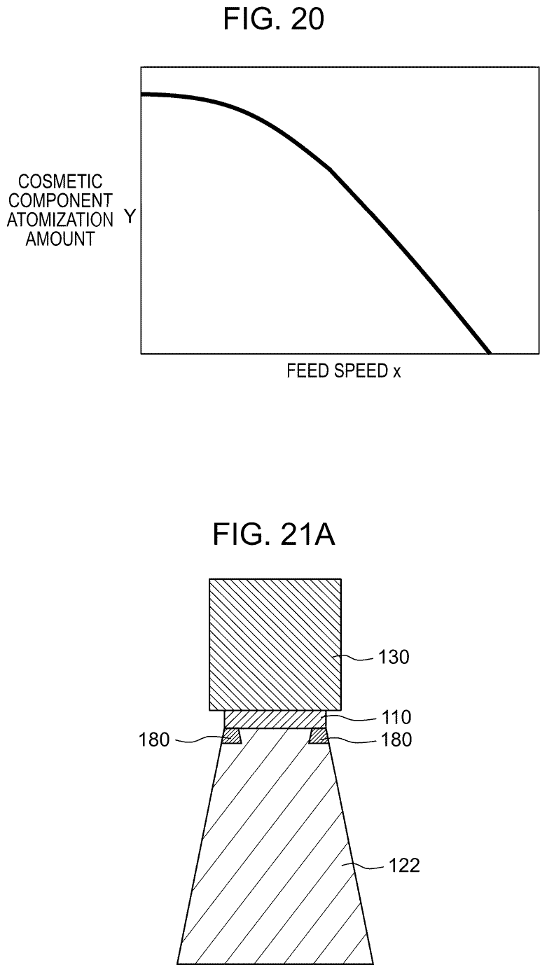

FIGS. 21A and 21B are views for describing a relationship between a heat area of cosmetic component 110 and an atomization amount of cosmetic component 110. FIG. 21A shows an example of a case where cosmetic component 110 is carried by supporter 180 of carrier 122 and brought into contact with atomizer 130. In addition, FIG. 21B shows an example of a case where a portion of carrier 122 carrying cosmetic component 110 is narrower than that of FIG. 21A, and in this case, an area where cosmetic component 110 contacts atomizer 130 is also narrower than that of FIG. 21A.

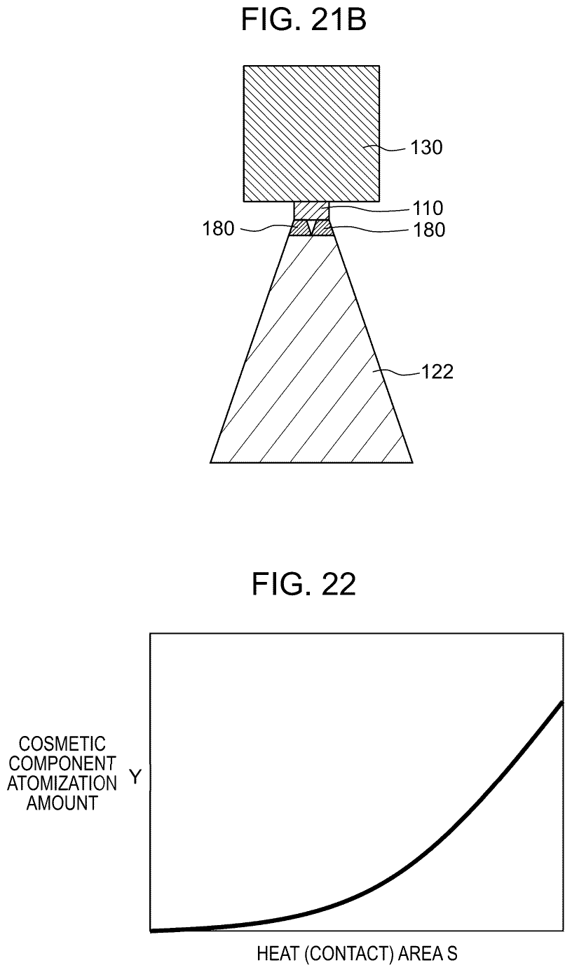

As shown in FIG. 22, the value of cosmetic component atomization amount Y increases with increasing in the area of cosmetic component 110 to be heated (i.e., brought into contact with atomizer 130). Thus, by changing the heat area of cosmetic component 110, cosmetic-component atomization apparatus 100 can flexibly adjust the atomization amount of cosmetic component 110 depending on the component and use of cosmetic component 110.

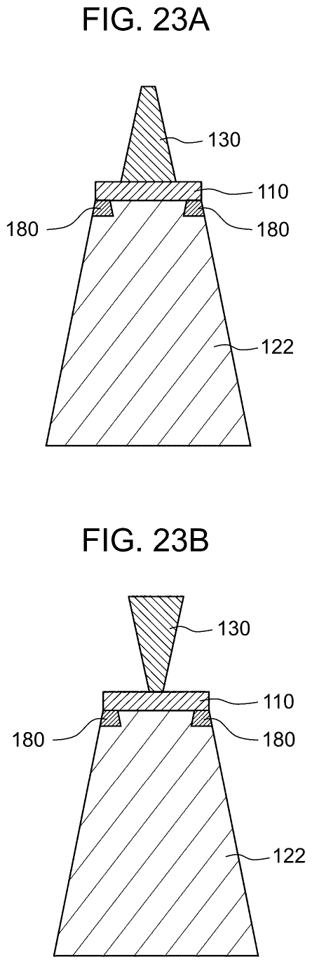

FIGS. 23A and 23B are views for explaining the relationship between the heat area of cosmetic component 110 and the atomization amount of cosmetic component 110, and show an example different from FIGS. 21A and 21B. FIG. 23A is an example of a case where cosmetic component 110 is carried by supporter 180 of carrier 122 and brought into contact with atomizer 130 having a wide contact portion. In addition, FIG. 23B shows an example of a case where a portion being in contact with cosmetic component 110 is narrower than that of FIG. 23A, and in this case, an area where cosmetic component 110 is in contact with atomizer 130 is also narrower than that of FIG. 23A.

Also in the case of the configuration shown in FIGS. 23A and 23B, as shown in FIG. 22, the value of cosmetic component atomization amount Y increases with the increasing in the area of cosmetic component 110 to be heated (i.e., brought into contact with atomizer 130). Thus, by changing the heat area of cosmetic component 110, cosmetic-component atomization apparatus 100 can flexibly adjust the atomization amount of cosmetic component 110 depending on the component and use of cosmetic component 110.

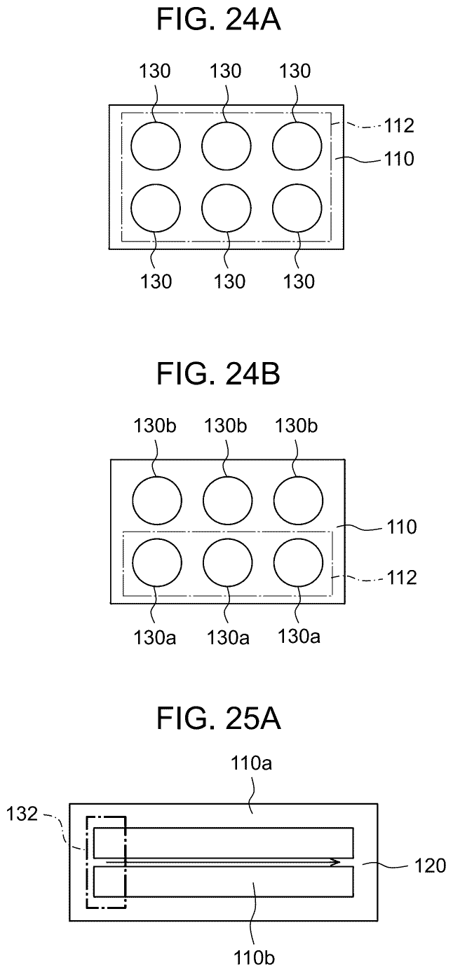

For example, for an area where atomizer 130 is in contact with cosmetic component 110, control device 200 may use a configuration in which a heat place is changed as shown in FIGS. 24A and 24B. For example, FIG. 24A shows an example of heat range 112 when all six circular atomizers 130 are heated. In addition, FIG. 24B shows heat range 112 when only three atomizers 130a are heated. As described above, adjusting atomizer 130 heated by control device 200 allows cosmetic-component atomization apparatus 100 to flexibly adjust the atomization amount of cosmetic component 110 depending on the component and use of cosmetic component 110.

As described above, cosmetic-component atomization apparatus 100 according to the second exemplary embodiment further includes control device 200 for controlling an operation of the at least one of atomizer 130 or driver 160. In addition, control device 200 adjusts an atomization amount of cosmetic component 110 depending on at least one of a distance from atomizer 130 to cosmetic component 110 or a heat range of cosmetic component 110. Thus, cosmetic-component atomization apparatus 100 can adjust the atomization amount of cosmetic component 110 to be atomized.

In addition, control device 200 of cosmetic-component atomization apparatus 100 may control atomizer 130 so as to heat a part or all of cosmetic component 110 in proximity. As a result, while cosmetic-component atomization apparatus 100 holds solid or semi-solid cosmetic component 110 at room temperature, cosmetic-component atomization apparatus 100 can atomize cosmetic component 110 by heating atomizer 130 when atomization is required, and can stably and appropriately supply cosmetic component 110. That is, cosmetic-component atomization apparatus 100 can stably and appropriately supply cosmetic component 110 by atomizing a necessary amount of cosmetic component 110 when necessary.

In addition, cosmetic-component atomization apparatus 100 according to the second exemplary embodiment further includes feed mechanism 170a and wind mechanism 170b that move carrier 120. Feed mechanism 170a and wind mechanism 170b move carrier 120 based on a predetermined rule to adjust the atomization amount of cosmetic component 110. Thus, cosmetic-component atomization apparatus 100 can atomize cosmetic component 110 newly by atomizing cosmetic component 110 of carrier 120 moved by feed mechanism 170a and wind mechanism 170b. In addition, in cosmetic-component atomization apparatus 100, control device 200 controls feed mechanism 170a and wind mechanism 170b, thereby allowing to adjust an atomization amount of cosmetic component 110 to be atomized.

In addition, feed mechanism 170a and wind mechanism 170b may move carrier 120 at a predetermined speed to adjust the atomization amount of cosmetic component 110. Thus, cosmetic-component atomization apparatus 100 can uniformly atomize cosmetic component 110 at heat position 132, and can supply a stable atomization amount.

In addition, feed mechanism 170a and wind mechanism 170b may stop moving carrier 120 at a certain period of time and then move carrier 120 at a predetermined speed. Thus, cosmetic-component atomization apparatus 100 can heat cosmetic component 110 for a certain period of time by stopping the movement of carrier 120 for the certain period of time, and can reliably atomize cosmetic component 110 at heat position 132.

In addition, cosmetic-component atomization apparatus 100 according to the second exemplary embodiment may further include a cosmetic component information storage unit. In addition, control device 200 may control the distance from atomizer 130 to cosmetic component 110, the temperature of atomizer 130, or the feed speed of feed mechanism 170a and wind mechanism 170b based on the information stored in the cosmetic component information storage unit. Thus, cosmetic-component atomization apparatus 100 can appropriately adjust the atomization amount of cosmetic component 110 depending on the feature of cosmetic component 110.

### Third Exemplary Embodiment

Then, the third exemplary embodiment will be described. In the following description, when the same reference numerals as those in the first and second exemplary embodiments are used, the same configurations as those in the first and second exemplary embodiments are shown, and the preceding description will be referred to unless otherwise specified. Hereinafter, cosmetic-component atomization apparatus 100 according to the third exemplary embodiment of the present disclosure, including a plurality of cosmetic components 110, will be described with respect to a configuration different from the first and the second exemplary embodiments.

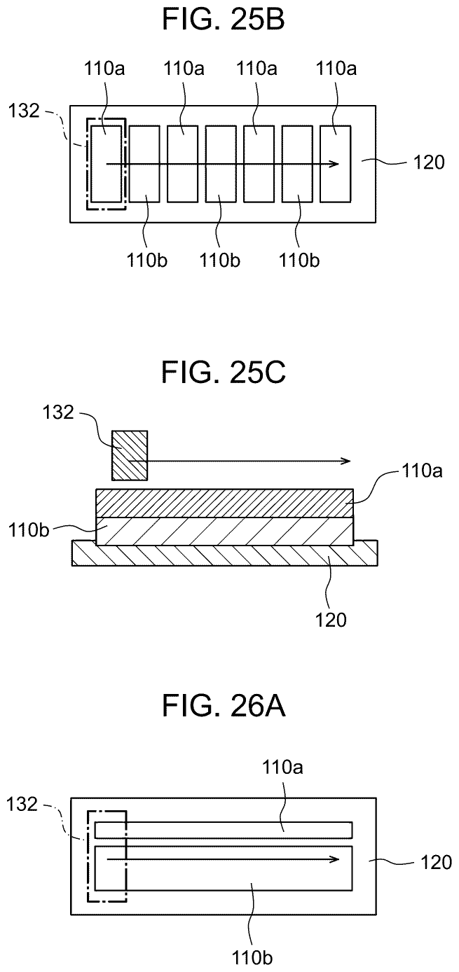

FIGS. 25A to 25C show examples of a case where two different types of cosmetic components 110a and 110b are carried on carrier 120. That is, in the examples shown in FIGS. 25A to 25C, carrier 120 includes a plurality of cosmetic component regions that carry different types of cosmetic components 110.

FIG. 25A shows an example of a case where two different types of cosmetic components 110a and 110b are both carried in parallel to the longitudinal direction of carrier 120. Thus, in the example shown in FIG. 25A, cosmetic-component atomization apparatus 100 can simultaneously atomize two different types of cosmetic components 110a and 110b. In addition, when the melting points of cosmetic component 110a and cosmetic component 110b are different from each other, control device 200 adjusts the heat temperature of atomizer 130 to atomize cosmetic component 110 having the higher melting point or to atomize both cosmetic component 110a and cosmetic component 110b.

FIG. 25B shows an example of a case where two different types of cosmetic components 110a and 110b are both carried alternately in the longitudinal direction of carrier 120. Thus, in the example shown in FIG. 25B, cosmetic-component atomization apparatus 100 can alternately atomize two different types of cosmetic components 110a and 110b, and can sufficiently provide the effect of each of cosmetic components 110. In addition, when the melting points of cosmetic component 110a and cosmetic component 110b are different from each other, control device 200 adjusts the heat temperature of atomizer 130 to atomize cosmetic component 110 having the higher melting point or to atomize both cosmetic component 110a and cosmetic component 110b.

FIG. 25C shows an example of a case where cosmetic component 110b is carried on carrier 120 with respect to two different types of cosmetic component 110a and cosmetic component 110b, and cosmetic component 110a is stacked in the upward direction in FIG. 25C of cosmetic component 110b. Thus, in the example shown in FIG. 25C, cosmetic-component atomization apparatus 100 heats cosmetic component 110a in such a manner that a short distance is formed therebetween, whereas cosmetic-component atomization apparatus 100 heats cosmetic component 110b in such a manner that a distance longer than the short distance is formed therebetween. Therefore, cosmetic-component atomization apparatus 100 can achieve, for example, adjustment of an appropriate atomization amount depending on a feature of each of cosmetic components 110a and 110b with respect to two types of cosmetic components 110a and cosmetic component 110b having different melting points. In addition, when the melting points of cosmetic component 110a and cosmetic component 110b are different from each other, control device 200 adjusts the heat temperature of atomizer 130 to atomize cosmetic component 110 having the higher melting point or to atomize both cosmetic component 110a and cosmetic component 110b.

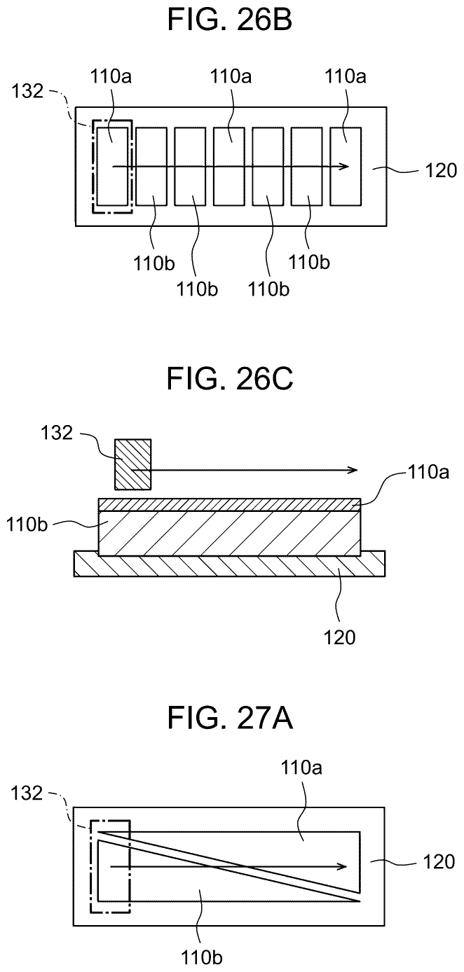

FIG. 26A shows an example of a case where the length in the short direction of carrier 120 of cosmetic component 110a and cosmetic component 110b is changed with respect to the configuration of cosmetic component 110 shown in FIG. 25A. As described above, in cosmetic-component atomization apparatus 100 shown in FIG. 26A, different atomization amounts can be set for cosmetic component 110a and cosmetic component 110b. In addition, when the melting points of cosmetic component 110a and cosmetic component 110b are different from each other, control device 200 adjusts the heat temperature of atomizer 130 to atomize cosmetic component 110 having the higher melting point or to atomize both cosmetic component 110a and cosmetic component 110b.

FIG. 26B shows a configuration in which the disposition rule of cosmetic component 110a and cosmetic component 110b in the longitudinal direction of carrier 120 is changed with respect to the configuration of cosmetic component 110 shown in FIG. 25B. In the example shown in FIG. 26B, the configuration in which cosmetic component 110b is disposed twice beside cosmetic component 110a is repeated. Thus, in the example shown in FIG. 26B, cosmetic-component atomization apparatus 100 can alternately atomize two different types of cosmetic components 110a and 110b based on a predetermined rule, and can sufficiently provide the effect of each of cosmetic components 110. In addition, when the melting points of cosmetic component 110a and cosmetic component 110b are different from each other, control device 200 adjusts the heat temperature of atomizer 130 to atomize cosmetic component 110 having the higher melting point or to atomize both cosmetic component 110a and cosmetic component 110b.

FIG. 26C shows an example of a case where the thickness of cosmetic component 110a in the vertical direction in FIG. 26C is reduced with respect to the configuration of cosmetic component 110 shown in FIG. 25C. Thus, cosmetic-component atomization apparatus 100 can achieve, for example, adjustment of an appropriate atomization amount depending on a feature of each of cosmetic components 110a and 110b with respect to two types of cosmetic components 110a and cosmetic component 110b having different melting points. In addition, when the melting points of cosmetic component 110a and cosmetic component 110b are different from each other, control device 200 adjusts the heat temperature of atomizer 130 to atomize cosmetic component 110 having the higher melting point or to atomize both cosmetic component 110a and cosmetic component 110b.

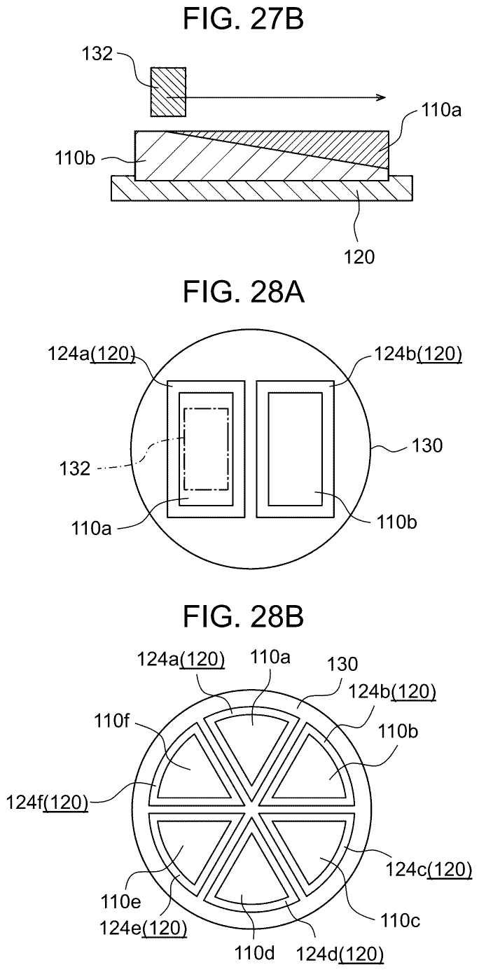

FIG. 27A shows an example of a case where the shapes of cosmetic component 110a and cosmetic component 110b are changed with respect to the configuration of cosmetic component 110 shown in FIG. 25A. As described above, in the example shown in FIG. 27A, after the start of heating, the atomization amount of cosmetic component 110b is large. As the heating proceeds to the second half, the atomization amount of cosmetic component 110a is increased, whereas the atomization amount of cosmetic component 110b is decreased. Thus, in cosmetic-component atomization apparatus 100 shown in FIG. 27A, an atomization amount of cosmetic component 110 can be adjusted in a lapse of time.

FIG. 27B shows an example of a case where thicknesses of cosmetic component 110a and cosmetic component 110b in the vertical direction in FIG. 26C are changed with respect to the configuration of cosmetic component 110 shown in FIG. 25 C. As described above, in the example shown in FIG. 27B, after the start of heating, the atomization amount of cosmetic component 110b is large. As the heating proceeds to the second half, the atomization amount of cosmetic component 110a is increased, whereas the atomization amount of cosmetic component 110b is decreased. Thus, in cosmetic-component atomization apparatus 100 shown in FIG. 27B, an atomization amount of cosmetic component 110 can be adjusted in a lapse of time.

In the third exemplary embodiment described above, an example of a case where two different types of cosmetic component 110a and cosmetic component 110b are carried on carrier 120 has been shown. In this third exemplary embodiment, the number of types of cosmetic components 110 carried by carrier 120 is not limited to two, and cosmetic-component atomization apparatus 100 may be configured to carry three or more types of cosmetic components 110.

As described above, in cosmetic-component atomization apparatus 100 according to the third exemplary embodiment, carrier 120 carries at least two types of cosmetic components 110. Thus, cosmetic-component atomization apparatus 100 can simultaneously atomize two different types of cosmetic components 110. In addition, when at least two types of cosmetic components 110 have different melting points, control device 200 adjusts a heating temperature of atomizer 130, thereby allowing to atomize cosmetic component 110 having a higher melting point or to atomize both of two types of cosmetic components 110. That is, cosmetic-component atomization apparatus 100 according to the third exemplary embodiment can adjust an atomization amount depending on features of at least two types of cosmetic components 110. In addition, control device 200 may selectively perform atomization, for example, alternate atomization to a plurality of cosmetic component regions. Thus, cosmetic-component atomization apparatus 100 can appropriately perform atomization depending on a plurality of cosmetic components 110 having different components and melting points.

In addition, the plurality of cosmetic component regions may be provided continuously or intermittently on carrier 120. Thus, cosmetic-component atomization apparatus 100 can perform appropriate atomization depending on features such as a melting point of cosmetic component 110.

In addition, in the third exemplary embodiment, when performing atomization to a plurality of cosmetic component regions, control device 200 may perform atomization with a time difference with respect to each of the plurality of cosmetic component regions to be atomized. In addition, control device 200 may change the atomization amount with respect to different cosmetic component regions depending on the lapse of time. Thus, cosmetic-component atomization apparatus 100 can perform appropriate atomization depending on in features such as a melting point of cosmetic component 110.

### Other Exemplary Embodiments

Although the present exemplary embodiments have been described above, the exemplary embodiment is not limited thereto, and various modifications can be made within the scope of the gist of the exemplary embodiment. In addition, some or all of various exemplary embodiments may be combined to form a new exemplary embodiment.

As shown in FIG. 2, cosmetic-component atomization apparatus 100 may include detector 300. Detector 300 may detect the atomization amount of cosmetic component 110 by using a sensor. Detector 300 may be composed of, for example, a gas sensor, a UV absorption rate (absorbance) change detection sensor, an absorbance change sensor, a mass detection sensor, a mass change detection sensor, a temperature detection sensor, and a use time measurement sensor. Control device 200 may control the at least one of atomizer 130 or driver 160 depending on the atomization amount of cosmetic component 110 detected by detector 300 to adjust the atomization amount. For example, when the detected atomization amount of cosmetic component 110 is larger than a predetermined atomization amount, the atomization amount is adjusted by performing control to lower the temperature of atomizer 130 or control to increase the distance between atomizer 130 and cosmetic component 110. Thus, cosmetic-component atomization apparatus 100 can adjust an appropriate atomization amount of cosmetic component 110 depending on the detected atomization amount.

In addition, detector 300 may be configured by a sensor to detect the at least one of the skin or hair state of the user. This detection of the at least one of the skin or hair state of the user by the sensor may be a general moisture or oil detection function or state detection by using an optical sensor. In addition, the image acquired by the camera may be analyzed to detect the at least one of the skin or hair state. Cosmetic-component atomization apparatus 100 may adjust the atomization amount of cosmetic component 110 depending on the at least one of the skin or hair state detected by detector 300. Thus, cosmetic-component atomization apparatus 100 can supply appropriate atomization of cosmetic component 110 depending on the state of the user.

In addition, control device 200 of cosmetic-component atomization apparatus 100 may detect the temperature of cosmetic component 110. In addition, when the detected temperature of cosmetic component 110 once becomes equal to or more than the melting point and then becomes equal to or less than the melting point, control device 200 may perform control for securing a distance from cosmetic component 110 to atomizer 130 or control for stopping heating of atomizer 130. Thus, cosmetic-component atomization apparatus 100 can prevent cosmetic component 110 that has once reached the melting point or more and then the melting point or less from being adhered to atomizer 130. Thus, the quality of cosmetic component 110 can be maintained.

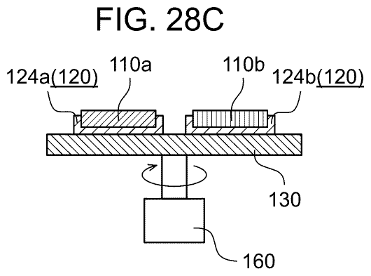

In addition, cosmetic-component atomization apparatus 100 may include a plurality of carriers 120 for carrying different cosmetic components 110. FIG. 28A is a view showing an example in which a plurality of carriers 124a and 124b are set in an upper portion of atomizer 130. FIG. 28B is a view showing an example in which a plurality of carriers 124a to 124f are set in the upper portion of atomizer 130. When it is not necessary to distinguish and describe carrier 124a to carrier 124f, they are denoted as carrier 120. In the examples shown in FIG. 28A and FIG. 28B, cosmetic components 110a to 110f are disposed on respective carriers 120. FIG. 28C shows an example of a case where, when cosmetic-component atomization apparatus 100 includes a plurality of carriers 120, cosmetic component 110 to be atomized by rotating atomizer 130 by using driver 160 is rotated. Thus, cosmetic-component atomization apparatus 100 can perform appropriate atomization depending on features such as a melting point of cosmetic component 110. In addition, control device 200 may rotate cosmetic component 110 to be atomized by atomizer 130 based on a learned model learned by machine learning. The learned model may be a model that learns, for example, the melting point of cosmetic component 110, the amount to be atomized, or the effect on the atomization time. Thus, cosmetic-component atomization apparatus 100 can perform more appropriate atomization depending on features such as a melting point of cosmetic component 110, an atomization amount, and an atomization time.

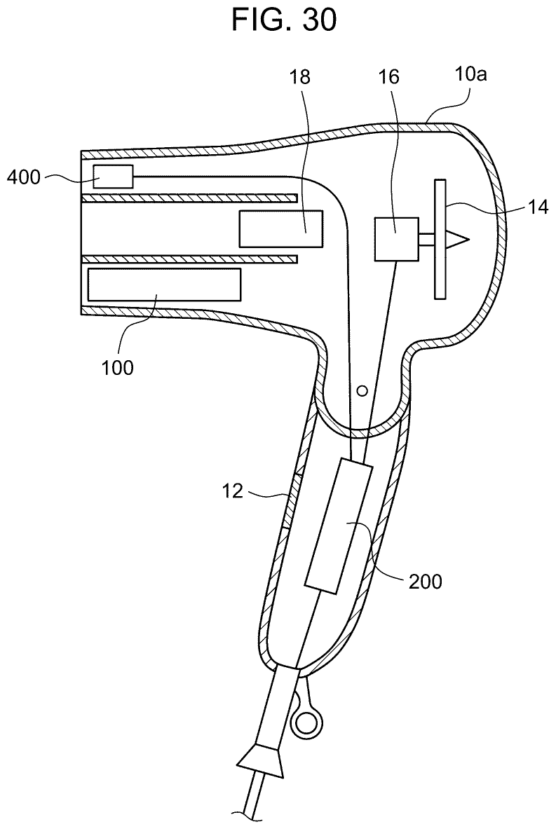

In addition, cosmetic device 10 may include charged fine particle generation device 400. In the present exemplary embodiment, charged fine particle generation device 400 is a device that generates charged fine particle water. In addition, charged fine particle generation device 400 may be a device that generates negative ions such as minerals. In addition, charged fine particle generation device 400 may be a device that generates nano ions that are negative ions surrounded by fine particle water. Charged fine particle generation device 400 may include both a device that generates charged fine particle water and a device that generates negative ions. FIG. 30 shows an example in which cosmetic device 10 applied to the hair dryer includes charged fine particle generation device 400. For example, in the hair dryer shown in FIG. 30, charged fine particles generated by charged fine particle generation device 400 are attached to the user's hair for a predetermined time, and then cosmetic component 110 atomized by cosmetic-component atomization apparatus 100 is attached to the user's hair. The predetermined time for attaching the charged fine particles generated by charged fine particle generation device 400 may be, for example, 1 minute. The predetermined time for attaching the charged fine particles generated by charged fine particle generation device 400 does not limit the configuration of the present exemplary embodiment, and may be shorter or longer than 1 minute as long as the effect on the attachment of the charged fine particles can be achieved. As described above, attaching the charged fine particles before attaching cosmetic component 110 allows the effect on the attachment of cosmetic component 110 to be enhanced. In addition, the timing at which cosmetic component 110 is discharged by cosmetic-component atomization apparatus 100 is not limited to the timing after charged fine particles generated by charged fine particle generation device 400 are discharged. For example, the timing at which cosmetic component 110 is discharged by cosmetic-component atomization apparatus 100 may be the same timing as the timing at which charged fine particles generated by charged fine particle generation device 400 are discharged, or may be before or after the discharge.

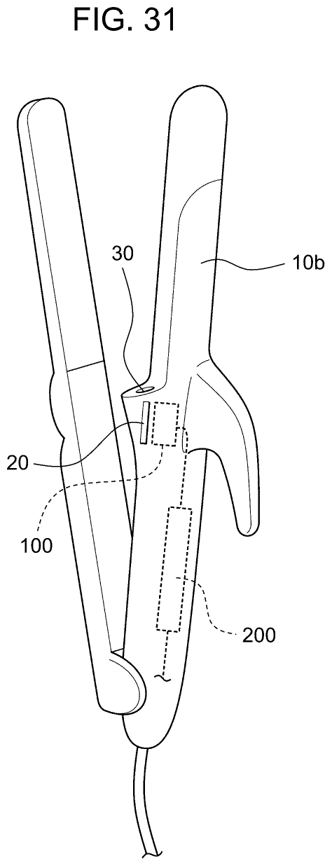

In addition, as cosmetic device 10, a configuration in which a hair iron includes cosmetic-component atomization apparatus 100 may be employed. FIG. 31 shows an example of a configuration of cosmetic device 10b when cosmetic-component atomization apparatus 100 is applied to a hair iron. Providing a hair iron with cosmetic-component atomization apparatus 100 allows cosmetic component 110 to be attached to the user's hair, and a stable cosmetic effect can be provided to the user's hair.

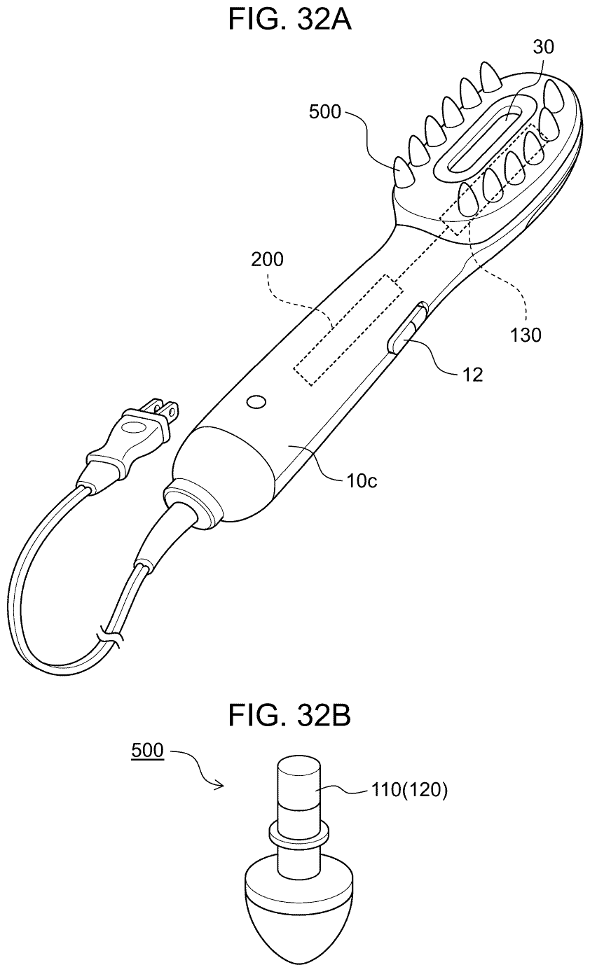

In addition, as cosmetic device 10, a configuration in which a hair brush includes cosmetic-component atomization apparatus 100 may be employed. FIG. 32A shows an example of a configuration of cosmetic device 10c when cosmetic-component atomization apparatus 100 is applied to a hair brush. In addition, FIG. 32B is a view showing a configuration of a plurality of brush portions 500 provided in cosmetic device 10c. As shown in FIG. 32B, cosmetic component 110 is provided at one end of brush portion 500. Providing cosmetic-component atomization apparatus 100 to the hair brush shown in FIG. 32A allows cosmetic component 110 provided to the plurality of brush portions 500 to be attached to the user's hair, and a stable cosmetic effect can be provided to the user's hair.

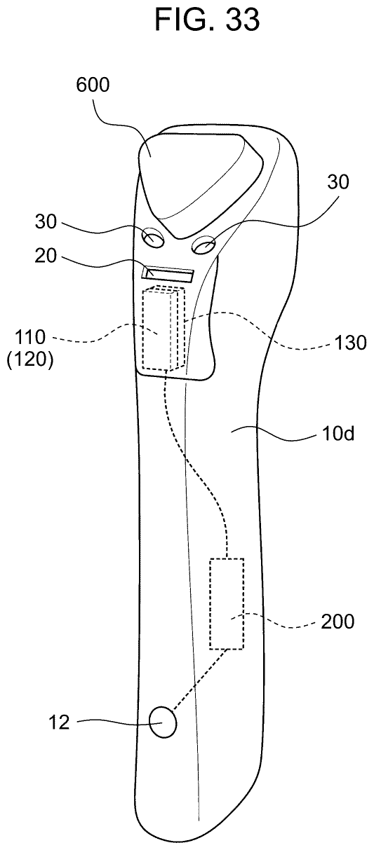

In addition, as cosmetic device 10, a configuration in which a facial care device includes cosmetic-component atomization apparatus 100 may be employed. FIG. 33 shows an example of a configuration of cosmetic device 10d when cosmetic-component atomization apparatus 100 is applied to a facial care device. Providing cosmetic-component atomization apparatus 100 to the facial care device shown in FIG. 33 allows cosmetic component 110 to be provided in a state where contact portion 600 is in contact with the skin of the user, and a stable cosmetic effect can be provided to the skin of the user.

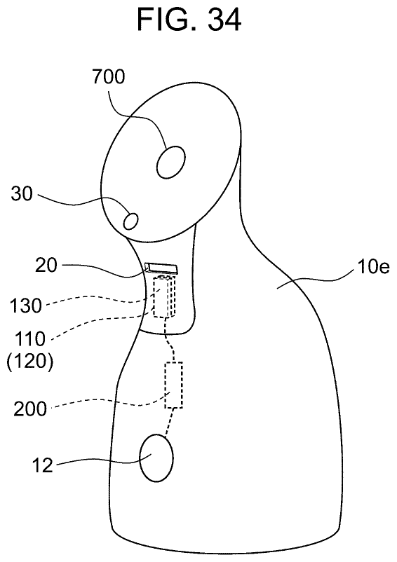

In addition, as cosmetic device 10, a configuration in which a steamer device includes cosmetic-component atomization apparatus 100 may be employed. FIG. 34 shows an example of a configuration of cosmetic device 10e when cosmetic-component atomization apparatus 100 is applied to a steamer. Providing the steamer shown in FIG. 34 to cosmetic-component atomization apparatus 100 allows cosmetic component 110 discharged from cosmetic component discharge port 30 to be provided together with steam discharged from steam outlet 700, and a stable cosmetic effect can be provided to the skin of the user.

In addition, cosmetic-component atomization apparatus 100 may be provided in an atomization device that ejects mist. The atomization device may be, for example, an automatic ejection device, an air purifier, a diffuser, an air spray, an air conditioner, a refrigerator, and a humidifier.

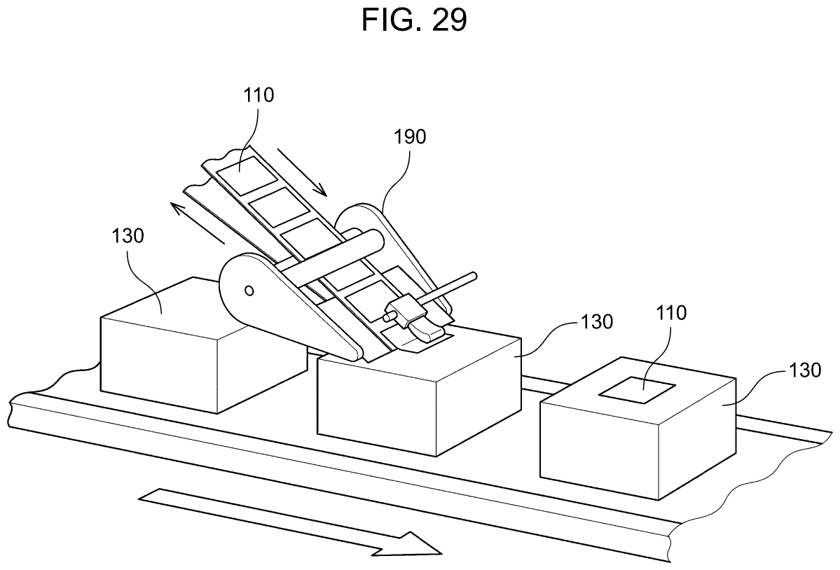

In addition, as shown in FIG. 29, cosmetic-component atomization apparatus 100 may include cosmetic component transfer mechanism 190 that transfers cosmetic component 110 to atomizer 130 as a mechanism. In the example shown in FIG. 29, cosmetic component 110 can be directly transferred to atomizer 130 by cosmetic component transfer mechanism 190, and carrier 120 does not have to be provided. Thus, cosmetic-component atomization apparatus 100 can achieve a configuration that is not affected by heat resistance of carrier 120. In addition, when transferred cosmetic component 110 is atomized, atomizer 130 moved in the direction of the arrow shown in FIG. 29 rotates in the horizontal direction, and cosmetic component 110 is transferred again by cosmetic component transfer mechanism 190. Thus, cosmetic-component atomization apparatus 100 can continuously atomize cosmetic component 110.

### (Note)

The above description of the exemplary embodiment discloses the following techniques.

(Technique 1) A cosmetic-component atomization apparatus for atomizing a cosmetic component and diffusing the cosmetic component into air, wherein the cosmetic-component atomization apparatus is configured to be provided for an atomization device or a cosmetic device configured to eject mist, and the cosmetic-component atomization apparatus comprises the cosmetic component that is solid or semi-solid at normal temperature; a carrier configured to carry the cosmetic component; and an atomizer configured to be brought close to at least one of the cosmetic component or the carrier and heat the cosmetic component to a temperature equal to or more than a melting point or a sublimation point of the cosmetic component to atomize the cosmetic component.

In such cosmetic-component atomization apparatus 100, cosmetic component 110 that is solid or semi-solid at normal temperature is carried by carrier 120 and is brought close to atomizer 130, and then, atomizer 130 heated to atomize cosmetic component 110. This makes it possible to use solid or semi-solid cosmetic component 110 for cosmetic-component atomization apparatus 100. Thus, it is possible to apply, to cosmetic-component atomization apparatus 100, cosmetic component 110 that is hardly oxidized, can be stored for a long period of time, and does not drip like a droplet in the apparatus. In addition, cosmetic-component atomization apparatus 100 is applicable to hydrophobic solid or semi-solid cosmetic component 110. Therefore, cosmetic-component atomization apparatus 100 is provided in cosmetic device 10, and can stably and appropriately supply cosmetic component 110.

(Technique 2) The cosmetic-component atomization apparatus according to technique 1, a driver configured to drive the atomizer to bring the atomizer and the cosmetic component close to each other by a predetermined distance.

In this configuration, cosmetic-component atomization apparatus 100 includes driver 160 that can bring atomizer 130 and cosmetic component 110 close to each other by a predetermined distance. Thus, cosmetic-component atomization apparatus 100 can atomize cosmetic component 110 appropriately depending on properties such as a melting point of cosmetic component 110.

(Technique 3) The cosmetic-component atomization apparatus according to technique 2, further comprising a controller for controlling operation of at least one the atomizer or the driver, wherein the controller is configured to adjust an atomization amount of the cosmetic component depending on a distance from the atomizer to the cosmetic component or a heat range of the cosmetic component.

In this configuration, control device 200 of cosmetic-component atomization apparatus 100 adjusts an atomization amount of cosmetic component 110 depending on at least one of a distance from atomizer 130 to cosmetic component 110 or a heat range of cosmetic component 110. Thus, cosmetic-component atomization apparatus 100 can adjust the atomization amount of cosmetic component 110 to be atomized.

(Technique 4) The cosmetic-component atomization apparatus according to technique 3, in which the controller is configured to control the atomizer to heat a part or all of the cosmetic component in proximity.

In this configuration, while cosmetic-component atomization apparatus 100 holds solid or semi-solid cosmetic component 110 at room temperature, cosmetic-component atomization apparatus 100 can atomize cosmetic component 110 by using heating atomizer 130 when atomization is required, and thus, cosmetic component 110 can be stably and appropriately supplied. That is, cosmetic-component atomization apparatus 100 can stably and appropriately supply cosmetic component 110 by atomizing a necessary amount of cosmetic component 110 when necessary.

(Technique 5) The cosmetic-component atomization apparatus according to technique 3 or 4, further including a feed mechanism configured to move the carrier; and a wind mechanism configured to move the carrier, wherein the feed mechanism and the wind mechanism are configured to move the carrier based on a predetermined rule to adjust the atomization amount of the cosmetic component.

In this configuration, feed mechanism 170a and wind mechanism 170b of cosmetic-component atomization apparatus 100 move carrier 120 based on a predetermined rule to adjust the atomization amount of cosmetic component 110. Thus, cosmetic-component atomization apparatus 100 can atomize new cosmetic component 110 by atomizing cosmetic component 110 of carrier 120 moved by feed mechanism 170a and wind mechanism 170b. In addition, in cosmetic-component atomization apparatus 100, control device 200 controls feed mechanism 170a and wind mechanism 170b, thereby allowing to adjust an atomization amount of cosmetic component 110 to be atomized.

(Technique 6) The cosmetic-component atomization apparatus according to technique 5, in which the feed mechanism and the wind mechanism move the carrier at a predetermined speed to adjust the atomization amount of the cosmetic component.

In this configuration, cosmetic-component atomization apparatus 100 can uniformly atomize cosmetic component 110 at heat position 132, and can supply a stable atomization amount.

(Technique 7) The cosmetic-component atomization apparatus according to technique 5, in which the feed mechanism and the wind mechanism move the carrier at a predetermined speed after stopping movement of the carrier for a certain period of time.

In this configuration, cosmetic-component atomization apparatus 100 can heat cosmetic component 110 for a certain period of time by stopping the movement of carrier 120 for the certain period of time, and can reliably atomize cosmetic component 110 at heat position 132.

(Technique 8) The cosmetic-component atomization apparatus according to technique 5, further including a cosmetic component information storage unit, wherein, based on information stored in the cosmetic component information storage unit, the controller is configured to control a distance from the atomizer to the cosmetic component, a temperature of the atomizer, or a feed speed of the feed mechanism and the wind mechanism.

In this configuration, cosmetic-component atomization apparatus 100 can appropriately adjust the atomization amount of cosmetic component 110 depending on the feature of cosmetic component 110 by using the information stored in the cosmetic component information storage unit.

(Technique 9) The cosmetic-component atomization apparatus according to any one of techniques 3 to 8, further including a detector configured to detect an atomization amount of an atomized cosmetic component, wherein, based on information detected by the detector, the controller is configured to control an atomization amount of the cosmetic component.

In this configuration, cosmetic-component atomization apparatus 100 adjusts the atomization amount of cosmetic component 110 depending on the atomization amount of cosmetic component 110 detected by detector 300. Thus, cosmetic-component atomization apparatus 100 can achieve atomization of cosmetic component 110 with an appropriate atomization amount depending on the atomization amount of cosmetic component 110.

(Technique 10) The cosmetic-component atomization apparatus according to any one of techniques 3 to 8, further including a detector configured to detect a state of at least of a skin or hair state of a user, wherein, based on information detected by the detector, the controller controls an atomization amount of the cosmetic component.

In this configuration, cosmetic-component atomization apparatus 100 adjusts the atomization amount of cosmetic component 110 depending on to the at least one of the skin state and the hair state detected by detector 300. Thus, cosmetic-component atomization apparatus 100 can supply appropriate atomization of cosmetic component 110 depending on the state of the user.

(Technique 11) The cosmetic-component atomization apparatus according to any one of techniques 3 to 10, in which the controller is configured to detect a temperature of the cosmetic component, and when a detected temperature of the cosmetic component once becomes equal to or more than a melting point and then becomes equal to or less than the melting point, the controller is configured to perform control to secure a distance from the cosmetic component to the atomizer or control to stop heating of the atomizer.

In this configuration, when the detected temperature of cosmetic component 110 once becomes equal to or more than the melting point and then becomes equal to or less than the melting point, control device 200 performs control for securing a distance from cosmetic component 110 to atomizer 130 or control for stopping heating of atomizer 130. Thus, cosmetic-component atomization apparatus 100 can prevent cosmetic component 110 that has once reached the melting point or more and then the melting point or less from being adhered to atomizer 130. Thus, the quality of cosmetic component 110 is maintained.

(Technique 12) The cosmetic-component atomization apparatus according to any one of techniques 1 to 11, in which the carrier carries at least two types of the cosmetic components.

In this configuration, cosmetic-component atomization apparatus 100 can simultaneously atomize two different types of cosmetic components 110. In addition, when at least two types of cosmetic components 110 have different melting points from each other, control device 200 adjusts a heating temperature of atomizer 130, thereby allowing to atomize cosmetic component 110 having a higher melting point or to atomize both of two types of cosmetic components 110.

(Technique 13) A cosmetic-component atomization apparatus for atomizing at least one cosmetic component and diffusing the cosmetic component into air, wherein the cosmetic-component atomization apparatus is configured to be provided for an atomization device or a cosmetic device configured to eject mist. The cosmetic-component atomization apparatus comprises at least one carrier configured to carry the cosmetic component that is solid or semi-solid at normal temperature; and an atomizer configured to be brought close to at least one of the cosmetic component or the carrier and heat the cosmetic component to a temperature equal to or more than a melting point or a sublimation point of the cosmetic component to atomize the cosmetic component.

In such cosmetic-component atomization apparatus 100, cosmetic component 110 that is solid or semi-solid at normal temperature is carried by carrier 120 and is brought close to atomizer 130, and then atomizer 130 is heated to atomize cosmetic component 110. This makes it possible to use solid or semi-solid cosmetic component 110 for cosmetic-component atomization apparatus 100. Thus, it is possible to apply, to cosmetic-component atomization apparatus 100, cosmetic component 110 that is hardly oxidized, can be stored for a long period of time, and does not drip like a droplet in the apparatus. In addition, cosmetic-component atomization apparatus 100 is applicable to hydrophobic solid or semi-solid cosmetic component 110. Therefore, cosmetic-component atomization apparatus 100 is provided in cosmetic device 10, and can stably and appropriately supply cosmetic component 110.

(Technique 14) The cosmetic-component atomization apparatus according to any one of techniques 1 to 12, in which the at least one carrier includes a plurality of carriers, the at least one cosmetic component includes a plurality of cosmetic components which are different from each other, the plurality of carriers are configured to carry the plurality of cosmetic components, and the plurality of carriers rotate the cosmetic components to be atomized by the atomizer.

In this configuration, cosmetic-component atomization apparatus 100 can perform appropriate atomization depending on features such as a melting point of cosmetic component 110.

(Technique 15) The cosmetic-component atomization apparatus according to any one of techniques 3 to 12 and 14, in which the controller further includes a drive controller, and the drive controller is a learned model that has learned appropriate rotation of the plurality of carriers by machine learning, and rotates the cosmetic component to be atomized by the atomizer.

In such configuration, thus, cosmetic-component atomization apparatus 100 can perform more appropriate atomization depending on the features such as a melting point of cosmetic component 110, an atomization amount, and an atomization time.

(Technique 16) A cosmetic device including the cosmetic-component atomization apparatus according to any one of techniques 1 to 15.

In such cosmetic device 10, cosmetic component 110 that is solid or semi-solid at normal temperature is carried by carrier 120 and is brought close to atomizer 130, and then, atomizer 130 is heated to atomize cosmetic component 110. This makes it possible to use solid or semi-solid cosmetic component 110 for cosmetic device. Thus, it is possible to apply, to cosmetic device 10, cosmetic component 110 that is hardly oxidized, can be stored for a long period of time, and does not drip like a droplet in the apparatus. Therefore, cosmetic device 10 can stably and appropriately supply cosmetic component 110.

(Technique 17) The cosmetic device according to technique 14, further including a charged fine particle generation device configured to generate charged fine particles, wherein the cosmetic component atomized by the cosmetic-component atomization apparatus is discharged after the charged fine particles generated by the charged fine particle generation device are discharged.

In this configuration, cosmetic device 10 discharges charged fine particles generated by charged fine particle generation device 400, and then discharges cosmetic component 110 atomized by cosmetic-component atomization apparatus 100. Thus, in cosmetic device 10, attaching the charged fine particles before attaching cosmetic component 110 allows the effect on the attachment of cosmetic component 110 to be enhanced.

(Technique 18) The cosmetic-component atomization apparatus according to any one of techniques 3 to 12 and 14 and 15, in which
the controller further includes a user detector that detects and specifies a user, and
further including a drive controller that adjusts the driver so as to have an appropriate atomization amount for the user specified by the user detector.

In this configuration, cosmetic-component atomization apparatus 100 can perform appropriate atomization depending on the state of the hair and skin of the user for cosmetic component 110.

(Technique 19) The cosmetic-component atomization apparatus according to any one of techniques 3 to 12, 14 and 15, and 18, further including a cosmetic component transfer unit that transfers the cosmetic component on the atomizer.

In this configuration, cosmetic-component atomization apparatus 100 can transfer cosmetic component 110 to atomizer 130 without including carrier 120, and can achieve a configuration that is not affected by heat resistance of carrier 120. In addition, using the configuration in which only cosmetic component 110 is brought into contact with atomizer 130 and carrier 120 is separated from atomizer 130, carrier 120 can be formed of a substance susceptible to heating. Thus, easiness of selection of the material of carrier 120 is improved.

(Technique 20) The cosmetic-component atomization apparatus according to techniques 5 to 12, including at least one of:
a drive controller that controls a distance from the cosmetic component and/or the carrier to the atomizer;
a heating controller that controls an area or a temperature to be atomized in the atomizer; and
a mechanism controller that controls a feed speed, a feed direction, or a feed timing of the feed mechanism and the wind mechanism.

In this configuration, cosmetic-component atomization apparatus 100 can perform appropriate atomization depending on features such as a melting point of cosmetic component 110.

(Technique 21) The cosmetic-component atomization apparatus according to techniques 10 to 12, in which
the detector is a state detector that detects a state of hair and skin of a user, the cosmetic-component atomization apparatus further including
a cosmetic component selector that selects a type of the cosmetic component depending on a situation in which the cosmetic component is applied to the hair according to the state of the user's hair detected by the state detector.

In this configuration, cosmetic-component atomization apparatus 100 can perform appropriate atomization depending on the state of the hair and skin of the user.

(Technique 22) The cosmetic-component atomization apparatus according to technique 21, in which the cosmetic component selector selects an appropriate cosmetic component based on a learned model learned by machine learning.

In this configuration, cosmetic-component atomization apparatus 100 can perform appropriate atomization depending on the state of the hair and skin of the user.

(Technique 23) The cosmetic-component atomization apparatus according to technique 21 or 22, in which the state detector detects an amount of moisture, a degree of dryness, a corresponding age, a color, a shape, or a temperature and humidity of hair and skin, and detects a state of the hair and skin of the user.

In this configuration, cosmetic-component atomization apparatus 100 can perform appropriate atomization depending on the state of the hair and skin of the user.

(Technique 24) The cosmetic-component atomization apparatus according to any one of techniques 1 to 23, in which the carrier is composed of a heat-resistant material, a heat-resistant fiber, metal, a silicon sheet, glass, or heat-resistant paper.

In this configuration, cosmetic-component atomization apparatus 100 can provide appropriate carrier 120 depending on the melting point or sublimation point of cosmetic component 110.

(Technique 25) The cosmetic-component atomization apparatus according to any one of techniques 1 to 24, in which the carrier is replaceable by a user.

In such cosmetic-component atomization apparatus 100, appropriate carrier 120 can be easily provided by the user depending on the melting point or sublimation point of cosmetic component 110.

(Technique 26) The cosmetic-component atomization apparatus according to any one of techniques 1 to 25, in which the carrier carries the cosmetic component having a high melting point and the cosmetic component having a low melting point.

In this configuration, cosmetic-component atomization apparatus 100 can appropriately perform atomization depending on a plurality of cosmetic components 110 having different components and melting points from each other.

(Technique 27) The cosmetic-component atomization apparatus according to any one of techniques 1 to 26, in which
the carrier includes a plurality of cosmetic component regions that carries different types of cosmetic components, and
the controller selectively or simultaneously atomizes the plurality of cosmetic component regions.

In this configuration, cosmetic-component atomization apparatus 100 can appropriately perform atomization depending on a plurality of cosmetic components 110 having different components and melting points from each other.

(Technique 28) The cosmetic-component atomization apparatus according to technique 27, in which the plurality of cosmetic component regions are continuously or intermittently provided on the carrier.

In this configuration, cosmetic-component atomization apparatus 100 can perform appropriate atomization depending on features such as a melting point of cosmetic component 110.

(Technique 29) The cosmetic-component atomization apparatus according to any one of techniques 3 to 12, in which the controller changes the heat position of the cosmetic component by meandering movement, reciprocating movement, zigzag movement, rotational movement, quick movement, or intermittent movement in the control of the operation of the carrier and/or the atomizer.

In this configuration, cosmetic-component atomization apparatus 100 can appropriately adjust the atomization amount of cosmetic component 110 depending on the feature of cosmetic component 110.

(Technique 30) The cosmetic-component atomization apparatus according to technique 27 or 29, in which the controller performs atomization while providing a time difference with respect to the different cosmetic component regions.

This configuration can perform appropriate atomization depending on features such as a melting point of cosmetic component 110.

(Technique 31) The cosmetic-component atomization apparatus according to any one of techniques 27, 29, and 30, in which the controller changes an atomization amount with respect to the different cosmetic component regions depending on a lapse of time.

This configuration can perform appropriate atomization depending on features such as a melting point of cosmetic component 110.

(Technique 32) The cosmetic device according to technique 17, in which the charged fine particles are nano ions or minerals that are negative ions wrapped in fine particle water.

In this configuration, cosmetic device 10 can increase the effect on the attachment of cosmetic component 110 by attaching the nano ions or the minerals.

(Technique 33) The cosmetic-component atomization apparatus of any one of techniques 1 to 32, in which the cosmetic device is a hair dryer, a steamer, or a hair iron.

In this configuration, using a hair dryer, a steamer, or a hair iron equipped with cosmetic-component atomization apparatus 100, cosmetic component 110 can be stably and appropriately supplied to the user.

The above-described exemplary embodiments are intended to exemplify the technique according to the present disclosure, and thus various modifications, replacements, additions, and omissions can be made within the scope of the appended claims or of their equivalents.

### INDUSTRIAL APPLICABILITY

The present disclosure is applicable to a cosmetic-component atomization apparatus that is provided in a cosmetic device and can stably and appropriately supply a cosmetic component. Specifically, the present disclosure is applicable to a hair dryer, a facial care device, and the like.

### REFERENCE MARKS IN THE DRAWINGS

10, 10a, 10b, 10c, 10d, 10e: cosmetic device
12: switch
14: fan
16: fan motor
18: heater
20: cosmetic component insertion port
30: cosmetic component discharge port
40: warm air discharge port
100: cosmetic-component atomization apparatus
110, 110a to 110f, 111: cosmetic component
112: heat range
120, 122, 124a to 124f: carrier
130, 130a, 130b: atomizer
132: heat position
140: housing
150: lid
160: driver
162: grip
170a: feed mechanism
170b: wind mechanism
170c: wind supporter
180: supporter
200: control device
210: controller
211: heating controller
212: drive controller
213: mechanism controller
214: carrier controller
215: state detector
216: user detector
217: cosmetic component transfer unit
218: cosmetic component selector
220: storage unit
221: user information DB
222: cosmetic component information DB
223: setting information DB
230: input/output IF
240: communication IF
300: detector
400: charged fine particle generation device
500: brush portion
600: contact portion

1. A cosmetic-component atomization apparatus for atomizing a cosmetic component and diffusing the cosmetic component into air,
wherein
the cosmetic-component atomization apparatus is configured to be provided for an atomization device or a cosmetic device configured to eject mist, and
the cosmetic-component atomization apparatus comprises:
the cosmetic component that is solid or semi-solid at normal temperature;
a carrier configured to carry the cosmetic component; and
an atomizer configured to be brought close to at least one of the cosmetic component or the carrier and heat the cosmetic component to a temperature equal to or more than a melting point or a sublimation point of the cosmetic component to atomize the cosmetic component.

2. The cosmetic-component atomization apparatus according to claim 1, comprising a driver configured to drive the atomizer to bring the atomizer and the cosmetic component close to each other by a predetermined distance.

3. The cosmetic-component atomization apparatus according to claim 2, further comprising:
a controller for controlling operation of at least one the atomizer or the driver,
wherein
the controller is configured to adjust an atomization amount of the cosmetic component depending on a distance from the atomizer to the cosmetic component or a heat range of the cosmetic component.

4. The cosmetic-component atomization apparatus according to claim 3, wherein
the controller is configured to control the atomizer to heat a part or all of the cosmetic component in proximity.

5. The cosmetic-component atomization apparatus according to claim 3, further comprising:
a feed mechanism configured to move the carrier; and
a wind mechanism configured to move the carrier,
wherein
the feed mechanism and the wind mechanism are configured to move the carrier based on a predetermined rule to adjust the atomization amount of the cosmetic component.

6. The cosmetic-component atomization apparatus according to claim 5, wherein
the feed mechanism and the wind mechanism move the carrier at a predetermined speed to adjust the atomization amount of the cosmetic component.

7. The cosmetic-component atomization apparatus according to claim 5, wherein
the feed mechanism and the wind mechanism move the carrier at a predetermined speed after stopping movement of the carrier for a certain period of time.

8. The cosmetic-component atomization apparatus according to claim 5, further comprising:
a cosmetic component information storage unit,
wherein
based on information stored in the cosmetic component information storage unit, the controller is configured to control a distance from the atomizer to the cosmetic component, a temperature of the atomizer, or a feed speed of the feed mechanism and the wind mechanism.

9. The cosmetic-component atomization apparatus according to claim 3, further comprising:
a detector configured to detect an atomization amount of an atomized cosmetic component,
wherein
based on information detected by the detector, the controller is configured to control an atomization amount of the cosmetic component.

10. The cosmetic-component atomization apparatus according to claim 3, further comprising:
a detector configured to detect a state of at least of a skin or hair state of a user, wherein
based on information detected by the detector, the controller controls an atomization amount of the cosmetic component.

11. The cosmetic-component atomization apparatus according to claim 3, wherein
the controller is configured to detect a temperature of the cosmetic component, and when a detected temperature of the cosmetic component once becomes equal to or more than a melting point and then becomes equal to or less than the melting point, the controller is configured to perform control to secure a distance from the cosmetic component to the atomizer or control to stop heating of the atomizer.

12. The cosmetic-component atomization apparatus according to claim 1, wherein
the carrier carries at least two types of the cosmetic components.

13. A cosmetic-component atomization apparatus for atomizing at least one cosmetic component and diffusing the cosmetic component into air,
wherein
the cosmetic-component atomization apparatus is configured to be provided for an atomization device or a cosmetic device configured to eject mist, and
the cosmetic-component atomization apparatus comprises:
at least one carrier configured to carry the cosmetic component that is solid or semi-solid at normal temperature; and
an atomizer configured to be brought close to at least one of the cosmetic component or the carrier and heat the cosmetic component to a temperature equal to or more than a melting point or a sublimation point of the cosmetic component to atomize the cosmetic component.

14. The cosmetic-component atomization apparatus according to claim 13, wherein
the at least one carrier includes a plurality of carriers,
the at least one cosmetic component includes a plurality of cosmetic components which are different from each other,
the plurality of carriers are configured to carry the plurality of cosmetic components, and
the plurality of carriers rotate the cosmetic components to be atomized by the atomizer.

15. The cosmetic-component atomization apparatus according to claim 3, wherein
the controller further includes a drive controller, and
the drive controller is a learned model that has learned appropriate rotation of the plurality of carriers by machine learning, and rotates the cosmetic component to be atomized by the atomizer.

16. A cosmetic device comprising the cosmetic-component atomization apparatus according to claim 1.

17. The cosmetic device according to claim 16, further comprising:
a charged fine particle generation device configured to generate charged fine particles,
wherein
the cosmetic component atomized by the cosmetic-component atomization apparatus is discharged after the charged fine particles generated by the charged fine particle generation device are discharged.

18. A cosmetic device comprising the cosmetic-component atomization apparatus according to claim 13.
